(19) United States
(12) Patent Application Publication
(10) Pub. No.: US 2020/0064793 A1
(43) Pub. Date: Feb. 27, 2020

(54) CONTROL SYSTEM AND CONTROL METHOD

(71) Applicant: Hitachi, Ltd., Tokyo (JP)

(72) Inventors: Ikumi INOUE, Tokyo (JP); Masashi KONO, Tokyo (JP)

(21) Appl. No.: 16/535,178

(22) Filed: Aug. 8, 2019

(30) Foreign Application Priority Data
Aug. 27, 2018 (JP) 2018-158421

(51) Int. Cl. G05B 15/02; B25J 13/00; G06F 17/15

(52) U.S. Cl. CPC G05B 15/02; G06F 17/15; B25J 13/003

(57) ABSTRACT

A control system that has a processor executing a program, a storage device storing the program, and a communication interface communicating with an external device inputting and outputting voice or video, outputs, when first external data regarding input voice, input video, an input text, or a text converted from the input voice or video is acquired from the external device, first response data to the first external data to the external device. The processor gives attribute information, which is an indicator of sharing availability of the first external data, to the first external data, and sets a weight to be an indicator of easiness of selection of the first external data to the first external data and stores the weight in the storage device, on the basis of the attribute information.

### INCORPORATION BY REFERENCE

This application claims priority based on Japanese patent application, No. 2018-158421 filed on Aug. 27, 2018, the entire contents of which are incorporated herein by reference.

### BACKGROUND

The present invention relates to a control system and a control method for controlling an external device.

The Internet of Things (IoT) technology that connects all devices to the Internet and provides various services has spread. During a rapid increase in the number of devices connected to the Internet, there is a need to manage information in a plurality of electronic devices connected to the Internet as knowledge.

Here, the information in the electronic devices is data. The knowledge is a set of “event or matter” and “content”. In the present specification, particularly, the acquisition of the knowledge by the electronic devices means having a set of “one or more semantic information” for “one information” as one data set. Further, during spreading of the electronic devices connected to the Internet, there is a need to manage information of not only one single device but also a plurality of devices.

One example is technology development of a robot system for providing various services to humans using communication. When robots communicate with humans, it is necessary to enhance the knowledge of the robots. Further, during spreading of the robots, there is a need to manage information of not only a single robot but also a plurality of robots.

Meanwhile, JP 2005-111603 A discloses a robot management device. The robot management device defines a data set as a knowledge set, and includes a communication unit that communicates with a plurality of robots via a network, a management unit that allocates the knowledge set to the plurality of robots and manages knowledge information collected by each of the plurality of robots in association with the knowledge set allocated to each robot, an intelligence unit that receives from any one of the plurality of robots environment information regarding a peripheral environment of the robot, performs predetermined processing on the environment information using the knowledge set allocated to the robot, and generates control information necessary for controlling the robot, and a provision unit that provides the control information to the robot via the network.

### SUMMARY

The robot management device disclosed in JP 2005-111603 A manages the information of the plurality of robots. However, by collectively managing and sharing information obtained from other robots, there is a possibility that the robot having obtained the information from other robots may make inappropriate speech or behavior.

An object of the present invention is to perform knowledge management enabling information selection to perform an appropriate operation by a device, even when information obtained from other devices is used.

A control system and a control method according to one aspect of the invention disclosed in the present application are a control system and a control method in which a processor executing a program, a storage device storing the program, and a communication interface communicating with an external device inputting and outputting voice or video are provided, and when first external data regarding the input voice, the input video, an input text, or a text converted from the input voice or video is acquired from the external device, first response data to the first external data is output to the external device. The processor gives attribute information regarding sharing availability of the first external data to the first external data, and sets a weight to be an indicator of easiness of selection of the first external data to the first external data and stores the weight in the storage device, on the basis of the attribute information.

According to a representative embodiment of the present invention, appropriate information sharing can be performed.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram illustrating a system configuration example of a management system;

FIG. 2 is a block diagram showing a hardware configuration example of a computer (an operation management server and an application server);

FIG. 3 is a block diagram showing a hardware configuration example of a robot;

FIG. 4 is a diagram illustrating a storage content example of a dictionary table;

FIGS. 5A to 5C are diagrams illustrating an example of attribute information;

FIG. 6 is a diagram illustrating a storage content example of a robot management table;

FIG. 7 is a diagram illustrating a storage content example of a master dictionary table;

FIG. 8 is a diagram illustrating a storage content example of a weight information table;

FIG. 9 is a diagram illustrating a storage content example of a contractor information table;

FIGS. 10A to 10C are diagrams illustrating a storage content example of a correlation table;

FIG. 11 is a sequence diagram showing a registration sequence example of a learning data set;

FIG. 12 is a flowchart showing a detailed processing procedure example of confirmation list generation processing (step S1103);

FIG. 13 is a diagram illustrating an example of a confirmation list;

FIG. 14 is a flowchart showing a detailed processing procedure example of learning list generation processing (step S1104);

FIG. 15 is a diagram illustrating an example of a learning list;

FIG. 16 is a flowchart showing a detailed processing procedure example of master dictionary table update processing (step S1106) shown in FIG. 11;

FIG. 17 is a flowchart showing a detailed processing procedure example of update list generation processing (step S1606) shown in FIG. 16;

FIG. 18 is a diagram illustrating an example of an update list;

FIG. 19 is a flowchart showing a weight update processing procedure example in the case where there is addition of a contractor in an operation management server;

FIG. 20 is a flowchart showing a weight list reflection processing sequence example in an application server;

FIG. 21 is a sequence diagram showing a usefulness redetermination sequence example of a learning data set;

FIG. 22 is a flowchart showing a detailed processing procedure example of utilization frequency measurement processing (step S2103) shown in FIG. 21; and

FIG. 23 is a flowchart showing a detailed processing procedure example of weight update processing (step S2106) shown in FIG. 21.

### DESCRIPTION OF THE EMBODIMENTS

Hereinafter, embodiments of the present invention will be described in detail on the basis of the drawings. However, the present invention is not analyzed as being limited to contents described in the following embodiments. Those skilled in the art can easily understand that a specific configuration can be changed and the embodiments can be combined, without departing from the spirit or the gist of the present invention.

In embodiments described below, the invention will be described in a plurality of embodiments or sections when required as a matter of convenience. However, these sections or embodiments are not irrelevant to each other unless otherwise stated and one relates to the entire or part of the other as a modification, details, or a supplementary explanation thereof.

Further, in the embodiments described below, when referring to the number of elements (including the number of pieces, values, amounts, ranges, and the like), the number of the elements is not limited to a specific number unless otherwise stated or except for the case in which the number is apparently limited to a specific number in principle and the number larger or smaller than the specified number is also applicable.

In addition, in the embodiments described below, it goes without saying that components (including element steps and the like) are not always indispensable unless otherwise stated or except for the case in which the components are apparently indispensable in principle.

<System Configuration Example>

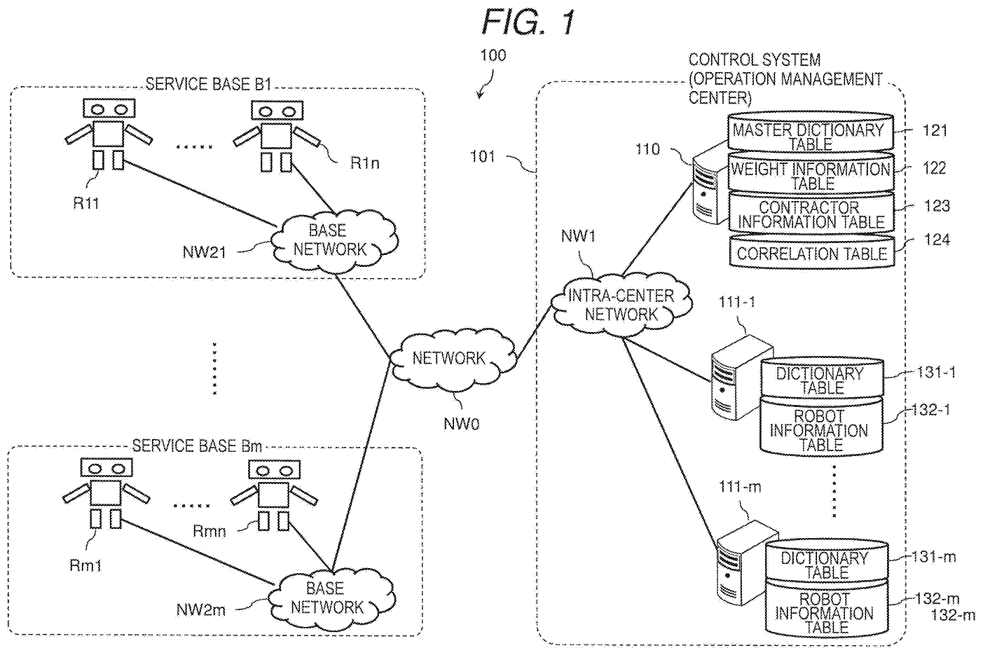

FIG. 1 is a diagram illustrating a system configuration example of a management system. A management system 100 includes a control system 101 to be an operation management center and one or more service bases B1 to Bm (m (m is an integer of m≥1) in FIG. 1). When the service bases B1 to Bm are not distinguished, they are simply referred to as the “service bases B”. The control system 101 and the service base B are communicatively connected to a network NW0, such as the Internet, a local area network (LAN), and a wide area network (WAN). The control system 101 manages the operation of the service in the service base B.

The control system 101 has an operation management server 110 and one or more (m(≥1) in FIG. 1) application servers 111-1 to 111-m. When the application servers 111-1 to 111-m are not distinguished, they are simply referred to as the “application servers 111”. The application server 111 may exist in the service base B. The number of application servers 111 may not be the same as the number of service bases B. The operation management server 110 and the application server 111 are communicatively connected to an intra-center network NW1 such as the Internet, the LAN, and the WAN, and are also communicatively connected to the service bases B1 to Bm via the network NW0.

The operation management server 110 manages the operation of the service base B by the application server 111. The operation management server 110 has a master dictionary table 121, a weight information table 122, a contractor information table 123, and a correlation table 124. The master dictionary table 121 exists for each type of data (voice data, text data, and video data).

The application server 111 controls the service base B in charge. In the present example, the application server 111-1 controls the service base B1, . . . , and the application server 111-m controls the service base Bm. The application servers 111-1 to 111-m have dictionary tables 131-1 to 131-m and robot management tables 132-1 to 132-m. When the dictionary tables 131-1 to 131-m are not distinguished, they are simply referred to as the “dictionary tables 131”. When the robot management tables 132-1 to 132-m are not distinguished, they are simply referred to as the “robot management tables 132”. The dictionary table 131 exists for each type of data (voice data, text data, and video data).

The service base B1 has one or more robots R11 to R1n (n (n is an integer of n≥1) in FIG. 1) and a base network NW21, . . . , and the service base Bm has one or more (n(≥1) in FIG. 1) robots Rm1 to Rmn and a base network NW2m. When the robots R11 to R1n, . . . , and Rm1 to Rmn are not distinguished in each service base B, they are simply referred to as the robots R1, . . . , and Rm. When the robots R11 to R1n, . . . , and Rm1 to Rmn are not distinguished in all service bases B1 to Bm, they are simply referred to as the robots R. Further, the number of robots R in the service base B may not be the same as the number of robots R in the other service bases B. When the base networks NW21 to NW2m are not distinguished in all the service bases B1 to Bm, they are simply referred to as the base networks NW2.

The robot R executes a specific service for a user in the service base B to which the robot R belongs. The specific service is a counter operation or a guide to the counter operation, for example. In the case of a financial institution, the robot R meets the requirements of the user of the robot R who has visited a store, and guides the user to a counter such as a deposit and a payment. Further, the robot R that performs the counter operation performs a counter operation such as the deposit and the payment for the user of the robot R who has visited the store. Further, the robot R may be mobile or fixed. The robot R interacts with the user of the robot R according to a preset scenario, and transmits external data such as voice and image (including a moving image) data of the user of the robot R to the application server 111 in charge.

The external data from the robot R is accumulated as teacher data in the application server 111, and supervised learning is performed. If the application server 111 receives the external data, the application server 111 sequentially updates learning parameters obtained by the supervised learning, and selects and outputs appropriate data to the robot R on the basis of the learning parameters. The robot R controls an operation of the robot R or speaks, on the basis of the data from the application server 111.

Although the operation management server 110 and the application server 111 are different computers, the operation management server 110 and at least a part of the application servers 111 may be integrated computers.

<Hardware Configuration Example of Computer>

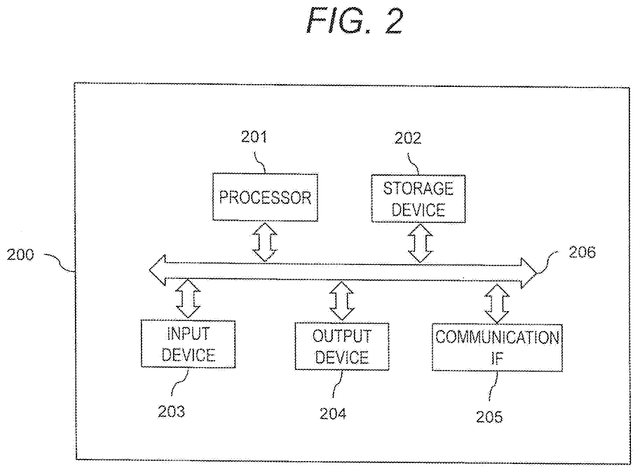

FIG. 2 is a block diagram showing a hardware configuration example of a computer (the operation management server 110 and the application server 111). A computer 200 has a processor 201, a storage device 202, an input device 203, an output device 204, and a communication interface (communication IF) 205. The processor 201, the storage device 202, the input device 203, the output device 204, and the communication IF 205 are connected by a bus 206. The processor 201 controls the computer 200. The processor 201 executes a program. The storage device 202 is a work area of the processor 201. Further, the storage device 202 is a non-transitory or transitory storage medium that stores various programs or data. Examples of the storage device 202 include a read only memory (ROM), a random access memory (RAM), a hard disk drive (HDD), and a flash memory. The input device 203 inputs data. Examples of the input device 203 include a keyboard, a mouse, a touch panel, a ten key, and a scanner. The output device 204 outputs data. Examples of the output device 204 include a display and a printer. The communication IF 205 is connected to the intra-center network NW0 and transmits and receives the data.

<Hardware Configuration Example of Robot R>

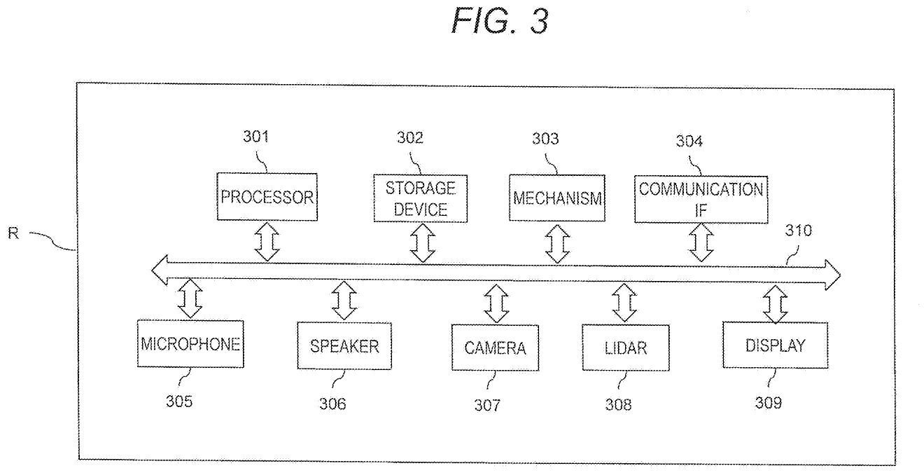

FIG. 3 is a block diagram showing a hardware configuration example of the robot R. The robot R has a processor 301, a storage device 302, a mechanism 303, a communication IF 304, a microphone 305, a speaker 306, a camera 307, a laser imaging detection and ranging (LIDAR) 308, and a display 309. The processor 301, the storage device 302, the mechanism 303, the communication IF 304, the microphone 305, the speaker 306, the camera 307, the LIDAR 308, and the display 309 are connected by a bus 310. The processor 301 controls the robot R. The processor 301 executes a program. The storage device 302 is a work area of the processor 301. Further, the storage device 302 is a non-transitory or transitory storage medium that stores various programs or data. Examples of the storage device 302 include a ROM, a RAM, an HDD, and a flash memory. The communication IF 304 is connected to the base network and transmits and receives the data.

The mechanism 303 is a structure that moves the robot R. The mechanism 303 is an arm, a leg, or other joint of the robot R, for example. The mechanism 303 may have wheels or a drive mechanism for rotationally driving the wheels. The microphone 305 is a device for inputting a voice of an external environment of the robot R. The microphone 305 is configured in an array, for example, and can also detect a direction from a sound source. The speaker 306 is a device that outputs voice data from the application server 111 to the external environment. The camera 307 is a device for imaging the external environment of the robot R. The LIDAR 308 is a device that emits an electromagnetic wave such as visible light to an obstacle and measures a reflected wave thereof, thereby measuring a distance to the obstacle in each direction on an observation plane. In the present embodiment, as an example, the observation plane is parallel to a ground surface, and a directional resolution is 1 degree. The display 309 is a device that displays an image.

<Storage Content Example of Various Tables>

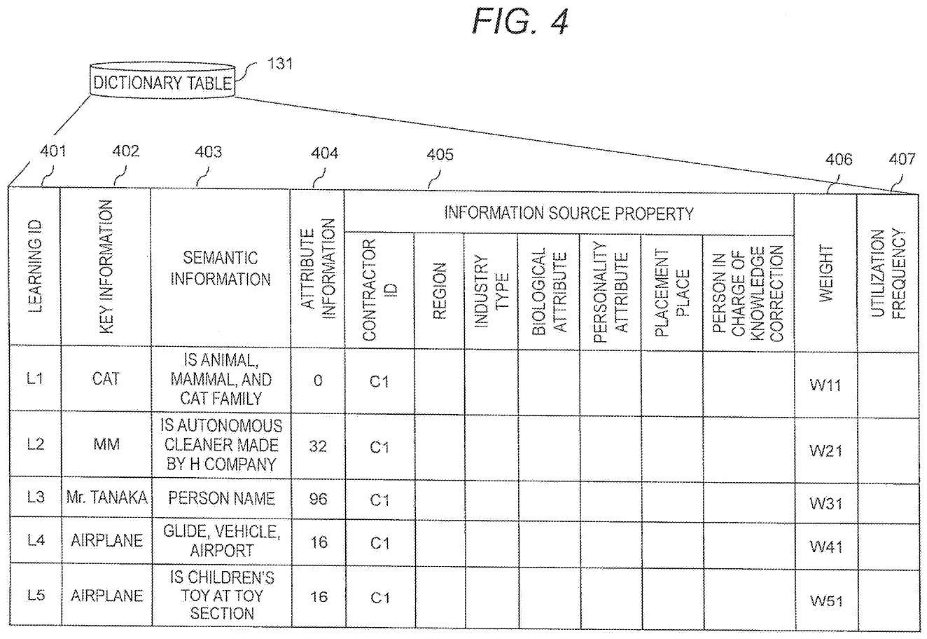

FIG. 4 is a diagram illustrating a storage content example of the dictionary table 131. The dictionary table 131 is a table held by the application server 111. The dictionary table 131 stores a learning data set. The learning data set is a substance of knowledge of the robot R. The dictionary table 131 is realized by the storage device 202 shown in FIG. 2.

The dictionary table 131 has, as fields, a learning ID 401, key information 402, semantic information 403, attribute information 404, an information source property 405, a weight 406, and a utilization frequency 407, and defines an entry to be a learning data set by a combination of values of the fields 401 to 407.

The learning ID 401 is identification information that uniquely identifies the learning data set. The key information 402 is information that is a core of external data input from the robot R. Specifically, for example, the key information 402 includes voice data input from the microphone 305, text data obtained by converting the voice data into a text by voice recognition, and video data (including a still image and a moving image) input from the camera 307. The input voice from the microphone 305 may include a voice uttered by the robot R, in addition to voices of humans interacting with the robot R. The key information 402 may be an address at which voice data, text data, and image data are stored.

For example, when a child asks the robot R “where a toy airplane is sold?”, terms (nouns) such as “toy” and “airplane” of the voice data input from the microphone 305 or the text data, and image data of a face of the child input from the camera 307 can become the key information 402. The robot R or the application server 111 may determine which information is to be the key information 402.

The semantic information 403 indicates a term indicating the meaning of the key information 402 or a related term. For example, if the key information 402 is “cat”, the semantic information 403 stores “animal”, “cute”, and the like. The semantic information 403 is information hit by a search from an external server or information obtained by correcting the information by the user of the application server 111. In the case where the semantic information 403 is different even if the key information 402 is identical, entries become different.

The attribute information 404 indicates an attribute of the key information 402. Examples of the attribute include presence or absence of confidentiality, presence or absence of contractor dependency, presence or absence of industry type dependency, presence or absence of region dependency, corresponding to an unnecessary word reason, and the like. The presence or absence of contractor dependency is an attribute indicating whether or not the key information 402 depends on a contractor. The key information 402 depending on the contractor may be, for example, the case where the key information 402 is an intra-company term of the contractor.

The presence or absence of industry type dependency is an attribute indicating whether or not the key information 402 depends on an industry type 603 of the contractor. The key information 402 depending on the industry type 603 may be, for example, the case where the key information 402 is a term (for example, an industry term) specific to the industry type 603 of the contractor. The presence or absence of the region dependency is an attribute indicating whether or not the key information 402 depends on a region 602 of the contractor.

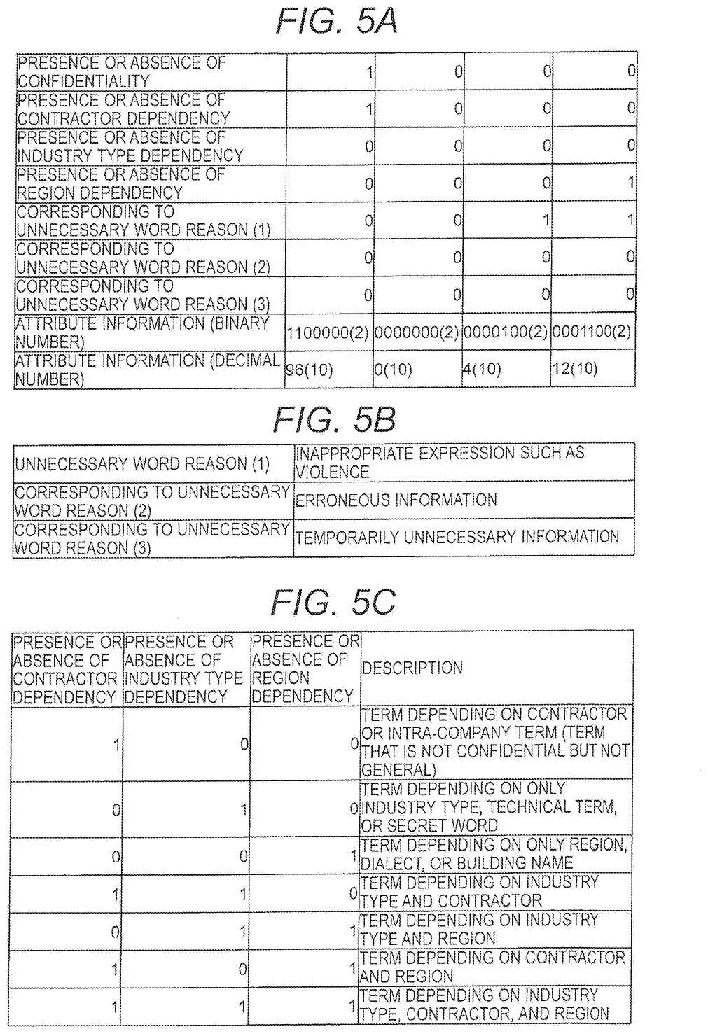

The key information 402 depending on the region 602 may be, for example, the case where the key information 402 is a term specific to the region 602 of the contractor (for example, a term specific to an area which is different from a dialect or a standard language). The attribute information 404 is given by the user of the application server 111. The details of the attribute information 404 will be described with reference to FIGS. 5A to 5C.

The information source property 405 is information indicating a feature of an information source that has output the key information 402. Strictly speaking, the information source that has output the key information 402 is, for example, a user who utters a voice or is projected as video. However, here, the information source is the robot R that has generated voice data, text data, or video data from the voice or the video, more specifically, a contractor who has made a usage contract with the robot R. Specifically, the information source property 405 has, for example, as sub-fields, a contractor ID, a region, an industry type, a biological attribute, a personality attribute, a placement place, and a person in charge of knowledge correction.

The contractor ID is identification information that uniquely identifies the contractor. The contractor is a person who has contracted from a manager of the management system 100 to use the robot R in the service base B, that is, a user of the robot R. The person who interacts with the robot R is a user who receives a service from the contractor in the service base B. The region is an area to be an assignment destination of the robot R. The industry type indicates a type of service operation performed by the robot R.

The biological attribute indicates a type (for example, male, female, old man, adult, child, or the like) when the robot R is compared to a living thing. The robot R speaks by a voice or an intonation according to the biological attribute. The personality attribute indicates a personality of the robot R such as wording. The robot R speaks by a voice or an intonation according to the personality attribute. The placement place indicates a place where the robot R is placed in the region. The person in charge of knowledge correction indicates a person in charge of correcting the content of the entry.

The weight 406 indicates a degree of importance that becomes an indicator of easiness of selection of the learning data set to be the entry. The larger a value of the weight 406, the more important it is. The larger the value of the weight 406, the easier it is to be selected as a generation source of response data to be returned to the robot R. The utilization frequency 407 indicates the frequency at which the key information 402 of the entry is utilized. If the utilization frequency 407 increases, the weight 406 also increases, and if the utilization frequency 407 decreases, the weight 406 also decreases.

<Example of Attribute Information 404>

FIGS. 5A to 5C are diagrams illustrating an example of the attribute information 404. FIG. 5A shows a combination of seven types of attributes. If a value of the attribute is “1”, it is “present”, and if the value of the attribute is “0”, it is “absent”. A bit string (binary number or decimal number) of a combination of attribute values is the attribute information 404. If the key information 402 corresponds to an unnecessary word in FIG. 5B, a value of “corresponding to the unnecessary word reason” is “1”. If the key information 402 does not correspond to the unnecessary word in FIG. 5B, the value is “0”. FIG. 5B shows a specific example of the unnecessary word reason among the seven types of attributes. FIG. 5C shows a dependency relation identified by a bit string of the presence or absence of contractor dependency, the presence or absence of industry type dependency, and the presence or absence of region dependency, among the seven types of attributes.

In FIG. 5C, for example, when the bit string is “100”, it indicates that the key information 402 is a term depending on the contractor or an intra-company term (term that is not confidential but not general). When the bit string is “010”, it indicates that the key information 402 is a term depending on only the industry type, a technical term, or a secret word. When the bit string is “001”, it indicates that the key information 402 is a term depending on only the region, a dialect, or a building name.

When the bit string is “110”, it indicates that the key information 402 is a term that depends on the industry type and the contractor. When the bit string is “011”, it indicates that the key information 402 is a term that depends on the industry type and the region. When the bit string is “101”, it indicates that the key information 402 is a term that depends on the contractor and the region. When the bit string is “111”, it indicates that the key information 402 is a term that depends on the contractor, the industry type, and the region.

The 7-bit string of the attribute values of FIG. 5A is set for each key information 402 by an operation input of the user (for example, a contractor) of the application server 111, and is stored as the attribute information 404 of the binary number or the decimal number (decimal number in FIG. 4) in the attribute information 404 of the dictionary table 131.

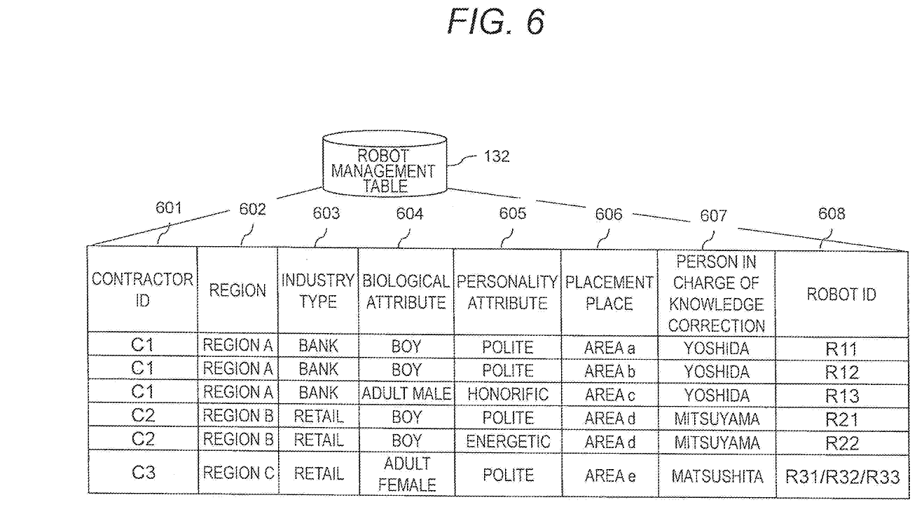

FIG. 6 is a diagram illustrating a storage content example of the robot management table 132. The robot management table 132 is a table held by the application server 111. The robot management table 132 is realized by the storage device 202 shown in FIG. 2. The robot management table 132 is a table that manages the robot R. The robot management table 132 has, as fields, a contractor ID 601, a region 602, an industry type 603, a biological attribute 604, a personality attribute 605, a placement place 606, a person in charge of knowledge correction 607, and a robot ID 608, and defines an entry to be robot management information by a combination of values of the fields 601 to 608.

The contractor ID 601 is identification information that uniquely identifies a contractor. The contractor is a person who has contracted from a manager of the management system 100 to use the robot R in the service base B, that is, a user of the robot R. The region 602 is an assignment destination of the robot R. The industry type 603 indicates a type of service operation performed by the robot R.

The biological attribute 604 indicates a type (for example, male, female, old man, adult, child, or the like) when the robot R is compared to a living thing. The robot R speaks by a voice or an intonation according to the biological attribute 604. The personality attribute 605 indicates a personality of the robot R such as wording. The robot R speaks by a voice or an intonation according to the personality attribute 605. The placement place 606 indicates a place where the robot R is placed in the region 602. The person in charge of knowledge correction 607 indicates a person in charge of correcting the content of the entry.

The robot ID 608 is identification information that uniquely identifies the robot R allocated in the entry. The contractor ID 601, the region 602, the industry type 603, the biological attribute 604, the personality attribute 605, the placement place 606, and the person in charge of knowledge correction 607 are stored as the information source property 405 in the dictionary table 131 described above.

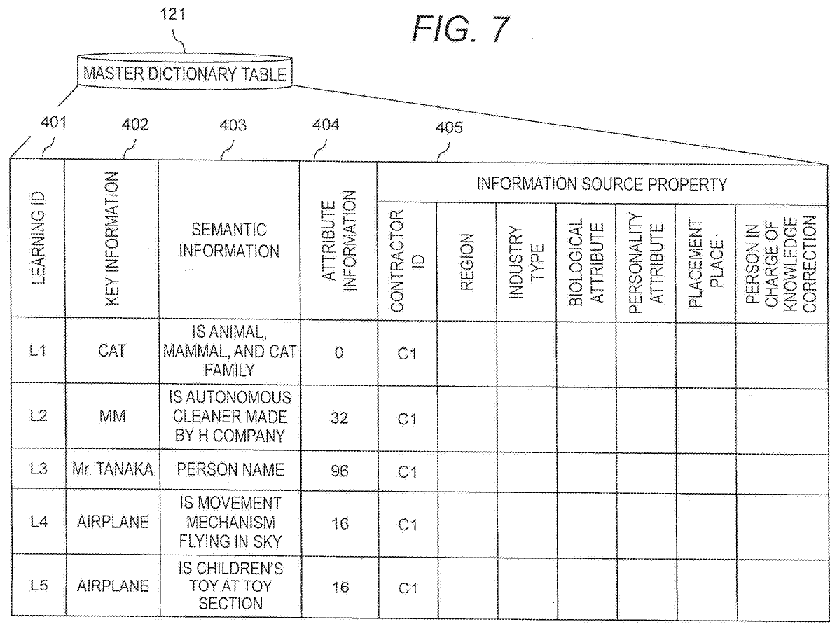

FIG. 7 is a diagram illustrating a storage content example of the master dictionary table 121. The master dictionary table 121 is a table in which the dictionary table 131 is integrated. The master dictionary table 121 is a table that is held by the operation management server 110. The master dictionary table 121 is realized by the storage device 202 shown in FIG. 2. The master dictionary table 121 has, as fields, a learning ID 401, key information 402, semantic information 403, attribute information 404, and an information source property 405.

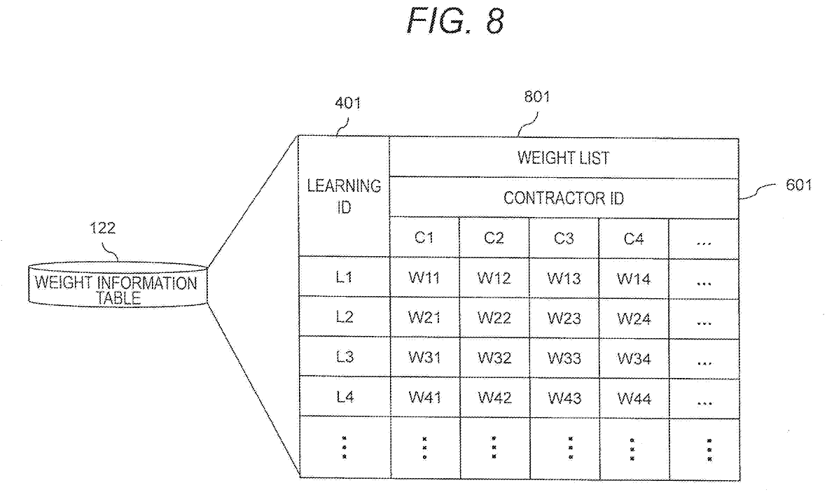

FIG. 8 is a diagram illustrating a storage content example of the weight information table 122. The weight information table 122 is a table that is held by the operation management server 110. The weight information table 122 is realized by the storage device 202 shown in FIG. 2. The weight information table 122 has, as fields, a learning ID 401 and a weight list 801. The weight list 801 is a weight 406 in each contractor ID 601 for each learning ID 401.

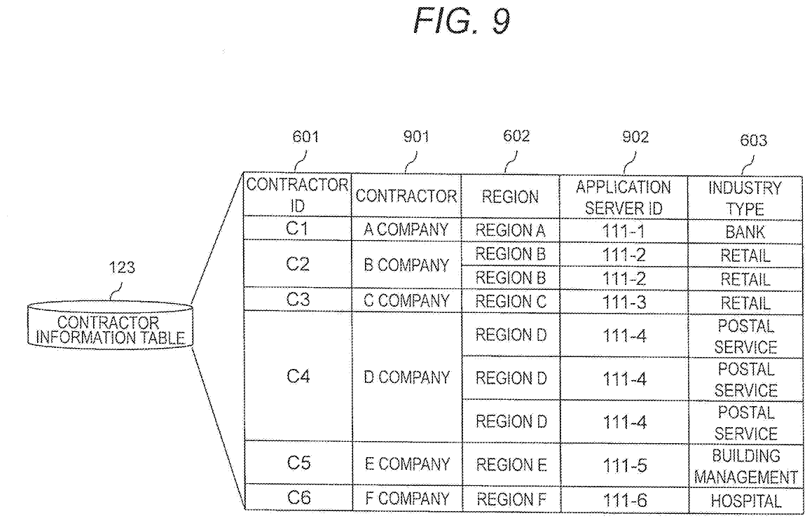

FIG. 9 is a diagram illustrating a storage content example of the contractor information table 123. The contractor information table 123 is a table that is held by the operation management server 110. The contractor information table 123 is realized by the storage device 202 shown in FIG. 2. The contractor information table 123 has, as fields, a contractor ID 601, a contractor 901, a region 602, an application server ID 902, and an industry type 603, and defines an entry to be contractor information by a combination of values of the fields 601 to 603, 901, and 902.

The contractor 901 indicates a person who has made a contract with the manager of the management system 100, that is, the user of the robot R. The region 602 is the service base B of the contractor 901, and indicates an assignment destination of the robot R. The application server ID 902 is identification information that uniquely identifies the application server 111 in charge of the service base B identified in the region 602.

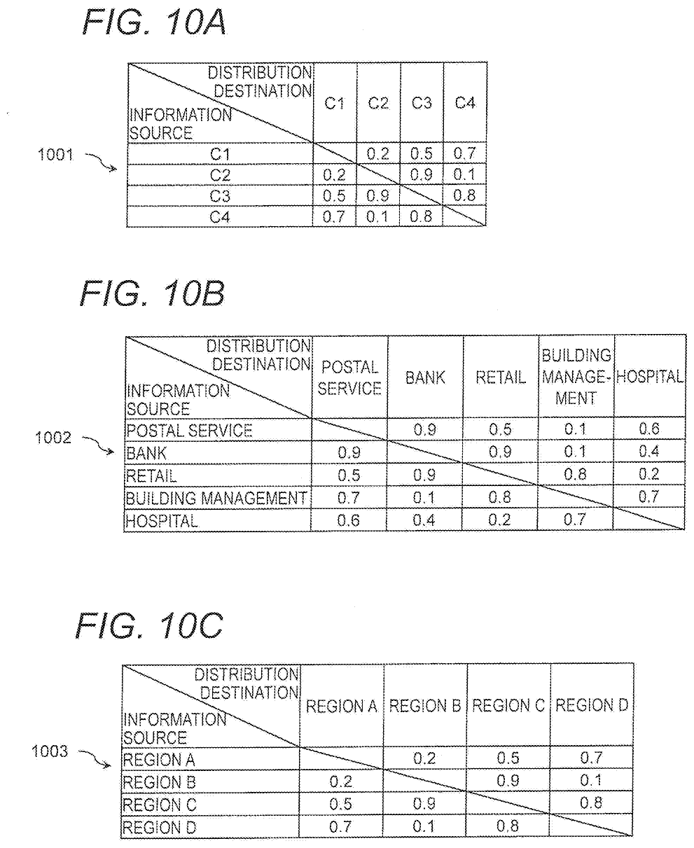

FIGS. 10A to 10C are diagrams illustrating a storage content example of the correlation table 124. Three types of correlation tables 124 are prepared to correspond to the attributes. The correlation table 124 is a table that is held by the operation management server 110. The correlation table 124 is realized by the storage device 202 shown in FIG. 2. FIG. 10A shows a contractor correlation table 1001, FIG. 10B shows an industry type correlation table 1002, and FIG. 10C shows a region correlation table 1003. A value of each correlation table 124 is fixed.

Further, in each correlation table 124, an “information source” is a contractor identified by the contractor ID 601 in the information source property 405 of the learning list created by the application server 111 on the basis of the external data. Further, a “distribution destination” is a value of a corresponding field of the contractor information table 123. For example, the distribution destination is a corresponding value of the contractor 901 in the case of the contractor correlation table 1001, a corresponding value of the industry type 603 in the case of the industry type correlation table 1002, and a corresponding value of the region 602 in the region correlation table 1003.

The contractor correlation table 1001 has a correlation value between contractors. The correlation value is a value between 0.0 and 1.0, and the closer to 1, the higher the effectiveness when information is shared. For example, it can be seen that the effectiveness for a B company (distribution destination) is higher in the case of information (correlation value 0.9) obtained from a C company (information source) rather than the case of information (correlation value 0.2) obtained from an A company (information source). Further, the industry type correlation table 1002 has a correlation value between the industry types 603, similar to the contractor correlation table 1001, and the region correlation table 1003 has a correlation value between the regions 602, similar to the contractor correlation table 1001.

<Registration Sequence Example of Learning Data Set>

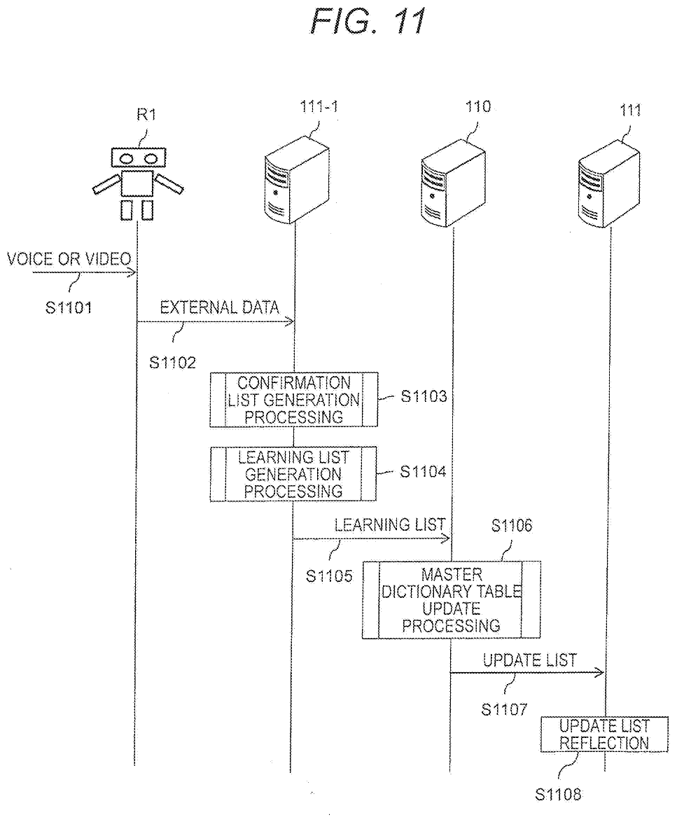

FIG. 11 is a sequence diagram showing a registration sequence example of the learning data set. Processing of the robot R shown in FIG. 11 is realized by causing the processor 301 to execute a program stored in the storage device 302 of the robot R. Each processing of the application server 111 and the operation management server 110 shown in FIG. 11 is realized by causing the processor 201 to execute a program stored in the storage device 202 of each of the application server 111 and the operation management server 110.

Further, in FIG. 11, the application server 111 that is a generation source of the confirmation list or the learning list is set as an application server 111-1 as an example, and the distribution destination of the update list is set as the application server 111 in charge of the service base B of a contractor different from the contractor using the application server 111-1.

The robot R receives an input of a voice or video from the microphone 305 or the camera 307 (step S1101), and generates external data. The external data includes input data and a robot ID 608 of the robot R to be the generation source. The input data is, for example, voice data, text data generated by voice recognition, and video data (including a still image and a moving image) subjected to video processing. The robot R transmits the external data to the application server 111 in charge via the base network NW2, the network NW0, and the intra-center network NW0 (step S1102).

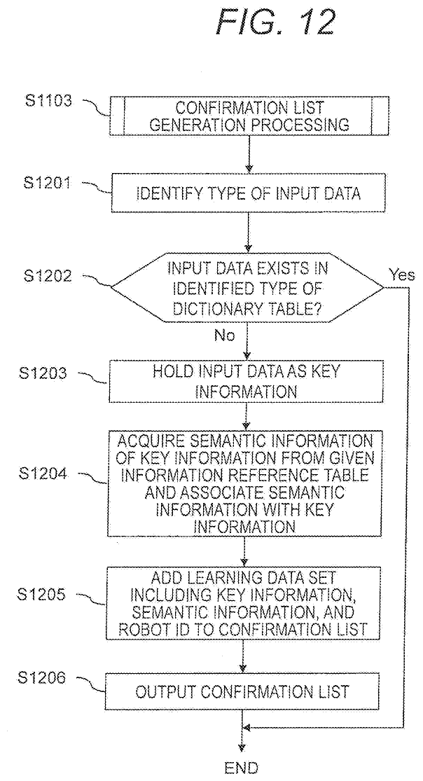

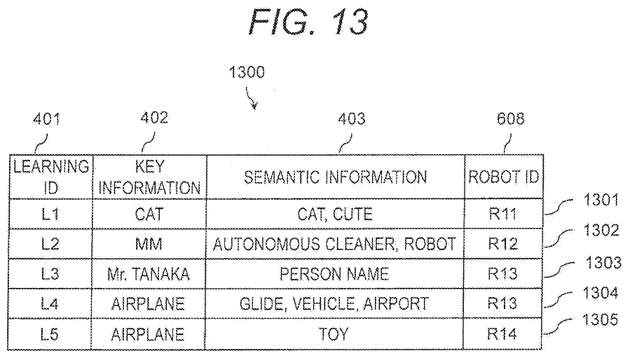

The application server 111 executes confirmation list generation processing (step S1103). The confirmation list generation processing (step S1103) is processing of acquiring new key information 402 from the external data and generating a confirmation list, which will be described later with reference to FIGS. 12 and 13.

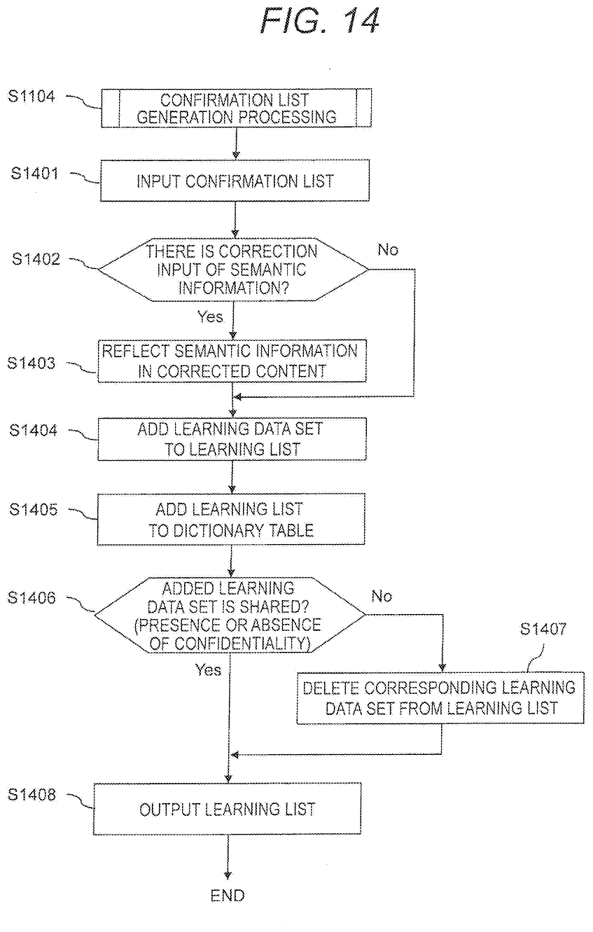

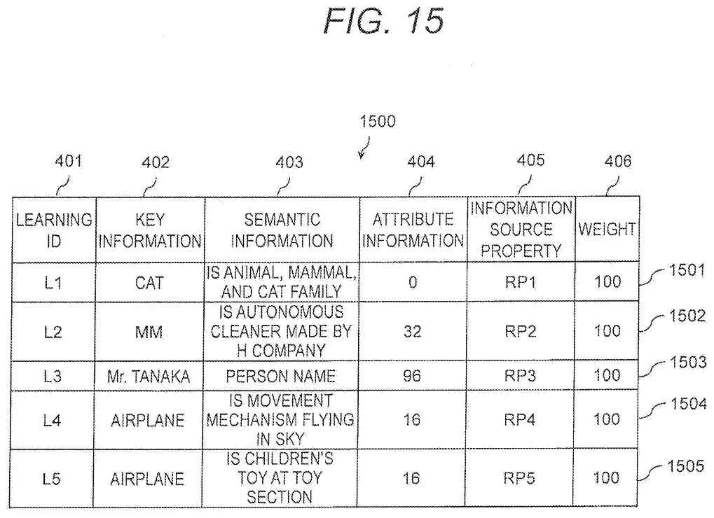

The application server 111 executes learning list generation processing (step S1104). The learning list generation processing (step S1104) is processing of generating a learning list from the confirmation list, which will be described later with reference to FIGS. 14 and 15.

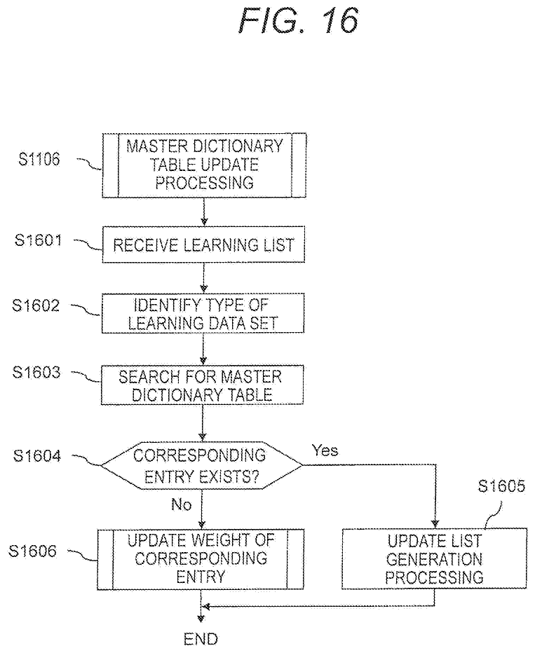

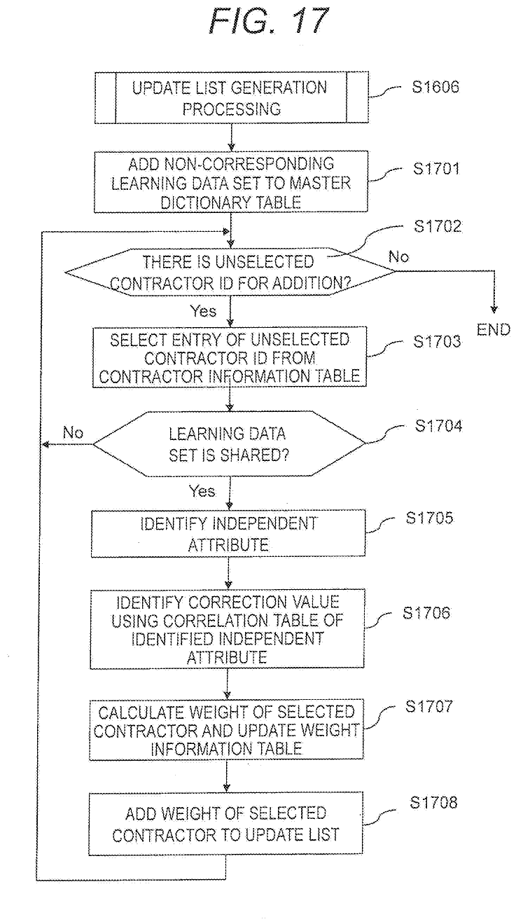

The application server 111 transmits the learning list to the operation management server 110 (step S1105). If the operation management server 110 receives the learning list, the operation management server 110 executes master dictionary table update processing (step S1106). The master dictionary table update processing (step S1106) is processing of updating the master dictionary table 121 with the contents of the learning list, which will be described later with reference to FIGS. 16 and 17.

The operation management server 110 distributes the update list to the application server 111 other than the application server 111-1 to be the transmission source of the learning list (step S1107). The other application server 111 reflects the update list in the dictionary table 131 (step S1108).

<Confirmation List Generation Processing (Step S1103)>

FIG. 12 is a flowchart showing a detailed processing procedure example of confirmation list generation processing (step S1103). The application server 111 identifies a type (voice data, text data, and video data) of the input data included in the external data (step S1201). The application server 111 determines whether or not the input data exists in the identified type of dictionary table 131 (step S1202).

When the input data exists in the identified type of dictionary table 131 (step S1202: Yes), the input data is not new data. For this reason, the application server 111 ends the confirmation list generation processing (step S1103). In this case, the subsequent learning list generation processing (step S1104) is not executed.

On the other hand, when the input data does not exist in the identified type of dictionary table 131 (step S1202: No), the input data is new data. For this reason, the application server 111 holds the input data as the key information 402 (step S1203).

Here, an example of the key information 402 from the voice data (or the text data) will be described. The case where the robot R is in charge of a reception operation is assumed.

User: “I will meet with Mr. Yamada of the planning department from 1 o'clock.”

Robot R @ Reception: “He is Yamada of our planning department, so I am investigating. Yamada is out, and it is scheduled to arrive at 1C40 at 13:30 on the schedule. I am very sorry to have kept you waiting. There is a break room where you can connect to wifi on a second floor of a building B next to a main building, so please wait for a while.”

In the case of the interaction, for example, if the “planning department”, “Yamada” and “meeting” uttered by the user are new input data, they become the key information 402.

Similarly, for example, if “our company planning department”, “out”, “schedule”, “1C40”, “main building”, and “B building 2 floor” uttered by the robot R are new input data, they become the key information 402.

The application server 111 acquires the semantic information 403 of the key information 402 from a given information reference table and associates the semantic information 403 with the key information 402 (step S1204). The given information reference table is a table that holds terms acquired from the network NW0 and terms associated with the terms. The given information reference table may be a table prepared in advance, or the application server 111 may periodically acquire and update information from the network NW0. The application server 111 acquires a term associated with the key information 402 as the semantic information 403 from the given information reference table.

The application server 111 generates a learning data set including the key information 402, the semantic information 403, and the robot ID 608 included in the external data for each key information 402, and adds the learning data set to the confirmation list (step S1205). Then, the application server 111 outputs the confirmation list (step S1206), and ends the confirmation list generation processing (step S1103).

FIG. 13 is a diagram illustrating an example of the confirmation list. A confirmation list 1300 includes a learning ID 401, key information 402, semantic information 403, and a robot ID 608. A learning data set 1301 includes key information 402 that is acquired from a robot R11 having the robot ID 608 of “R11”. A learning data set 1302 includes key information 402 that is acquired from a robot R12 having the robot ID 608 of “R12”. Each of learning data sets 1303 and 1304 includes key information 402 that is acquired from a robot R13 having the robot ID 608 of “R13”. Since the learning data sets 1301 to 1305 are data generated by the application server 111-1 at almost the same time, they are stored in one confirmation list 1300.

<Learning List Generation Processing (Step S1104)>

FIG. 14 is a flowchart showing a detailed processing procedure example of learning list generation processing (step S1104). The application server 111 inputs the confirmation list 1300 (step S1401), and waits for a correction input of the semantic information 403 from the user (step S1402). When there is not the correction input of the semantic information 403 (step S1402: No), the application server 111 proceeds to step S1404.

When there is the correction input of the semantic information 403 (step S1402: Yes), the application server 111 reflects the semantic information 403 in the corrected content (step S1403), and proceeds to step S1404. In step S1404, the application server 111 adds the learning data set to the learning list (step S1404).

The learning data set is data obtained by adding attribute information 404, an initial value (for example, 100) of a weight 406, and an information source property 405 to each of the learning data sets in the confirmation list 1300. The attribute information 404 is added by the input of the user. The larger the value of the weight 406, the higher the importance. The information source property 405 is the contractor ID 601, the region 602, the industry type 603, the biological attribute 604, the personality attribute 605, and the placement place 606 in the entry of the robot ID 608 included in the learning data set in the confirmation list 1300.

Then, the application server 111 adds the learning data set in the learning list to the dictionary table 131 (step S1405). Then, the application server 111 determines whether or not the added learning data set is shared with other application servers 111 (step S1406). Specifically, for example, the application server 111 determines whether a value of “presence or absence of confidentiality” of the attribute information 404 is “1” (confidential) or “0” (not confidential) for each learning data set in the learning list.

When the value of the “presence or absence of confidentiality” is “1” (confidential) for all learning data sets in the learning list (step S1406: Yes), the application server 111 proceeds to step S1408. When there is a learning data set in which the value of the “presence or absence of confidentiality” is “0” (not confidential) (step S1406: No), the application server 111 does not share the learning data set with other application servers 111. For this reason, the application server 111 deletes the corresponding learning data set from the learning list (step S1407), and proceeds to step S1408. In step S1408, the application server 111 outputs the learning list (step S1408), and ends the learning list generation processing (step S1104).

FIG. 15 is a diagram illustrating an example of the learning list. A learning list 1500 includes a learning ID 401, key information 402, semantic information 403, attribute information 404, an information source property 405, and a weight 406. Among learning data sets 1501 to 1505, a value of the attribute information 404 of the learning data set 1503 is “96”, so that the value of the presence or absence of confidentiality is “1”. Therefore, the learning data set 1503 is deleted from the learning list 1500 in step S1407.

<Master Dictionary Table Update Processing (Step S1106)>

FIG. 16 is a flowchart showing a detailed processing procedure example of master dictionary table update processing (step S1106) shown in FIG. 11. The operation management server 110 receives the learning list 1500 from the application server 111 (step S1601), and identifies a type of learning data set (voice data, text data, or video data) (step S1602). Then, the operation management server 110 searches for a learning data set from the identified type of master dictionary table 121 (step S1603).

When the corresponding entry exists in the master dictionary table 121 (step S1604: Yes), the operation management server 110 updates the weight 406 of the corresponding entry to the weight 406 (with an initial value 100) of the matched learning data set in the weight information table 122 (step S1605).

Specifically, for example, when the learning ID 401 of the learning data set is “L1” and the contractor ID 601 identified by the information source property 405 of the learning data set is “C1”, the operation management server 110 updates a value W11 of the weight 406 to the initial value 100.

On the other hand, when the corresponding entry does not exist in the master dictionary table 121 (step S1604: No), the operation management server 110 executes the update list generation processing (step S1606). The update list generation processing (step S1606) is processing of generating an update list from a learning data set not corresponding to the master dictionary table 121 in the learning list 1500, which will be described later with reference to FIG. 17.

FIG. 17 is a flowchart showing a detailed processing procedure example of the update list generation processing (step S1606) shown in FIG. 16. The operation management server 110 adds the non-corresponding learning data set in step S1605 to the master dictionary table 121 (step S1701). The operation management server 110 determines whether or not there is an unselected contractor ID 601 for the additional entry (step S1702).

When there is the unselected contractor ID 601 (step S1702: Yes), the operation management server 110 selects an entry of the unselected contractor ID 601 from the contractor information table 123 (step S1703). Then, the operation management server 110 determines whether or not the learning data set is shared with other contractors other than the contractor (selected contractor) of the selected entry (step S1704).

Specifically, for example, for each of the added learning data sets, the operation management server 110 refers to the attribute information 404, and identifies the presence or absence of contractor dependency, the presence or absence of industry type dependency, and the presence or absence of region dependency from the attribute information 404.

In the case where a value of the presence or absence of contractor dependency is “1” (present), if the selected contractor identified from the information source property 405 of the learning data set and other contractor are matched, the operation management server 110 determines that the learning data set can be shared. Specifically, for example, in the case where the contractor ID 601 of the selected contractor identified by the information source property 405 of the learning data set is “C2”, if the contractor ID 601 of other contractor is “C2”, the contractors are identical, so that the operation management server 110 proceeds to step S1704: Yes. If the contractor ID 601 of other contractor is not “C2”, the contractors are not identical, so that the operation management server 110 proceeds to step S1704: No. When the value of the presence or absence of contractor dependency is “0” (absent), it is not considered whether the contractors are identical or different. When a bit string of the presence or absence of contractor dependency, the presence or absence of industry type dependency, and the presence or absence of region dependency is “100”, the above processing is performed.

In the case where a value of the presence or absence of industry type dependency is “1” (present), if the industry type 603 identified from the information source property 405 of the learning data set and the industry type 603 of other contractor are matched, the operation management server 110 determines that the learning data set can be shared. Specifically, for example, in the case where the industry type 603 identified by the information source property 405 of the learning data set is “bank”, if the industry type 603 of other contractor is “bank”, the industry types are identical, so that the operation management server 110 proceeds to step S1704: Yes. If the industry type 603 of other contractor is not “bank”, the industry types are not identical, so that the operation management server 110 proceeds to step S1704: No. When the value of the presence or absence of industry type dependency is “0” (absent), it is not considered whether the industry types 603 are identical or different. When a bit string of the presence or absence of contractor dependency, the presence or absence of industry type dependency, and the presence or absence of region dependency is “010”, the above processing is performed.

In the case where a value of the presence or absence of region dependency is “1” (present), if the region 602 identified from the information source property 405 of the learning data set and the region 602 of other contractor are matched, the operation management server 110 determines that the learning data set can be shared. Specifically, for example, in the case where the region 602 identified by the information source property 405 of the learning data set is “A”, if the region 602 of other contractor is “A”, the regions are identical, so that the operation management server 110 proceeds to step S1704: Yes. If the region 602 of other contractor is not “A”, the regions are not identical, so that the operation management server 110 proceeds to step S1704: No. When the value of the presence or absence of region dependency is “0” (absent), it is not considered whether the regions 602 are identical or different. When a bit string of the presence or absence of contractor dependency, the presence or absence of industry type dependency, and the presence or absence of region dependency is “001”, the above processing is performed.

Further, when the bit string of the presence or absence of contractor dependency, the presence or absence of industry type dependency, and the presence or absence of region dependency is “110”, as long as the contractors are identical and the industry types are identical, sharing of the learning data set is allowed, and the operation management server 110 proceeds to step S1704: Yes.

Similarly, when the bit string of the presence or absence of contractor dependency, the presence or absence of industry type dependency, and the presence or absence of region dependency is “101”, as long as the contractors are identical and the regions are identical, sharing of the learning data set is allowed, and the operation management server 110 proceeds to step S1704: Yes.

Similarly, when the bit string of the presence or absence of contractor dependency, the presence or absence of industry type dependency, and the presence or absence of region dependency is “011”, as long as the industry types are identical and the regions are identical, sharing of the learning data set is allowed, and the operation management server 110 proceeds to step S1704: Yes.

Similarly, when the bit string of the presence or absence of contractor dependency, the presence or absence of industry type dependency, and the presence or absence of region dependency is “111”, as long as the contractors are identical, the industry types are identical, and the regions are identical, sharing of the learning data set is allowed, and the operation management server 110 proceeds to step S1704: Yes.

Further, when the bit string of the presence or absence of contractor dependency, the presence or absence of industry type dependency, and the presence or absence of region dependency is “000”, sharing of the learning data set is unconditionally allowed, and the operation management server 110 proceeds to step S1704: Yes.

Next, the operation management server 110 identifies an independent attribute for each of the additional learning data sets that can be shared (step S1705). The independent attribute is an attribute of a value “0” indicating independency in the bit string of the presence or absence of contractor dependency, the presence or absence of industry type dependency, and the presence or absence of region dependency. Specifically, for example, when the bit string of the presence or absence of contractor dependency, the presence or absence of industry type dependency, and the presence or absence of region dependency is “100”, the independent attributes are the industry type 603 and the region 602.

Next, the operation management server 110 identifies a correlation value using the correlation table 124 of the identified independent attribute (step S1706). If the identified independent attribute is contractor dependency, the operation management server 110 refers to the contractor correlation table 1001, if the identified independent attribute is industry type dependency, the operation management server 110 refers to the industry type correlation table 1002, and if the identified independent attribute is region dependency, the operation management server 110 refers to the region correlation table 1003.

Specifically, for example, when the bit string of the presence or absence of contractor dependency, the presence or absence of industry type dependency, and the presence or absence of region dependency is “100”, the independent attributes are the industry type dependency and the region dependency, so that the operation management server 110 refers to the industry type correlation table 1002 and the region correlation table 1003.

For the correlation table 124 of the reference destination, the operation management server 110 sets the selected contractor as the “information source” and sets other contractor as the “distribution destination”. Specifically, for example, when the correlation table 124 of the reference destination is the contractor correlation table 1001, the operation management server 110 identifies the contractor ID 601 of the selected contractor from the information source, and identifies the contractor ID 601 of other contractor from the distribution destination different from the information source. For example, when the information source is “C1,” for each of the distribution destinations different from the information source, the operation management server 110 acquires a correlation value “0.2” with the distribution destination “C2”, acquires a correlation value “0.5” with the distribution destination “C3”, and acquires a correlation value “0.7” with the distribution destination “C4”.

When the correlation table 124 of the reference destination is the industry type correlation table 1002, the operation management server 110 identifies the industry type 603 of the selected contractor from the information source, and identifies the industry type 603 of the distribution destination from the distribution destination different from the information source. For example, when the industry type 603 of the information source is “postal service”, for each of the distribution destinations different from the information source, the operation management server 110 acquires a correlation value “0.9” with the industry type 603 “bank” of the distribution destination, acquires a correlation value “0.5” with the industry type 603 “retail” of the distribution destination, acquires a correlation value “0.1” with the industry type 603 “building management” of the distribution destination, and acquires a correlation value “0.6” with the industry type 603 “hospital” of the distribution destination.

When the correlation table 124 of the reference destination is the region correlation table 1003, the operation management server 110 identifies the region 602 of the selected contractor from the information source, and identifies the region 602 of the distribution destination from the distribution destination different from the information source. For example, when the region 602 of the information source is “A,” for each of the distribution destinations different from the information source, the operation management server 110 acquires a correlation value “0.2” with the distribution destination region 602 “B”, acquires a correlation value “0.5” with the distribution destination region 602 “C”, and acquires a correlation value “0.7” with the distribution destination region 602 “D”.

It will be described more specifically. For example, when the bit string of the presence or absence of contractor dependency, the presence or absence of industry type dependency, and the presence or absence of region dependency is “011”, the independent attribute is the contractor dependency, so that the contractor correlation table 1001 is referred to. For example, when the contractor ID 601 of the selected contractor is “C1,” from the contractor correlation table 1001, the operation management server 110 acquires a correlation value “0.2” with the distribution destination “C2”, acquires a correlation value “0.5” with the distribution destination “C3”, and acquires a correlation value “0.7” with the distribution destination “C4”.

Then, the operation management server 110 calculates a value of the weight 406 of the selected contractor for each distribution destination, and updates the weight information table 122 (step S1707). Specifically, the operation management server 110 calculates the weight 406 for each distribution destination by multiplying the correlation value by the initial value (100) of the weight 406 for each distribution destination. In this example, a value W12 of the weight 406 of the information source “C1” considering the correlation with the distribution destination “C2” becomes W12=20 (=0.2×100). Similarly, a value W13 of the weight 406 of the information source “C1” considering the correlation with the distribution destination “C3” becomes W13=50 (=0.5×100). Similarly, a value W14 of the weight 406 of the information source “C1” considering the correlation with the distribution destination “C4” becomes W14=70 (=0.7×100).

Further, for example, when the bit string of the presence or absence of contractor dependency, the presence or absence of industry type dependency, and the presence or absence of region dependency is “100”, the independent attributes are the industry type dependency and the region dependency, so that the industry type correlation table 1002 and the region correlation table 1003 are referred to. The contractor ID 601 of the selected contractor is set as “C1”, the industry type 603 of “C1” is set as “bank”, and the region 602 of “C1” is set as “D”. Further, the industry type 603 of the distribution destination “C2” is set as “building management” and the region 602 is set as

The operation management server 110 acquires a correlation value “0.1” with the industry type 603 “Building management” of the distribution destination “C2” from the industry type correlation table 1002, and acquires a correlation value “0.7” with the region 602 “A” of the distribution destination “C2” from the region correlation table 1003. In this case, the value W12 of the weight 406 of the information source “C1” considering the correlation with the industry type 603 and the region 602 of the distribution destination “C2” becomes W12=80 (=(0.1+0.7)×100). The operation management server 110 calculates the values W13 and W14 of the weight 406 by similar calculation processing for other distribution destinations C3 and C4.

That is, when the learning data set is shared with other contractors, the operation management server 110 calculates the weight 406 in consideration of the independent attribute. Therefore, when the number of independent attributes increases and the correlation value increases, the value of the weight 406 increases. When the weight 406 is larger, the key information 402 of the entry of the weight 406 is likely to be selected as data to be output from the robot R.

Then, the operation management server 110 adds the learning data set and the value of the calculated weight 406 of the selected contractor to the update list (step S1708), and returns to step S1702. In step S1702, when there is no unselected contractor ID 601 for the addition (step S1702: No), the operation management server 110 ends the update list generation processing (step S1606). Then, as shown in FIG. 11, the operation management server 110 transmits the update list including the value of the calculated weight 406 to other application servers 111 (step S1107), and other application servers 111 reflect the weight 406 in the update list (step S1108). As a result, the weights 406 of other application servers 111 have the latest values.

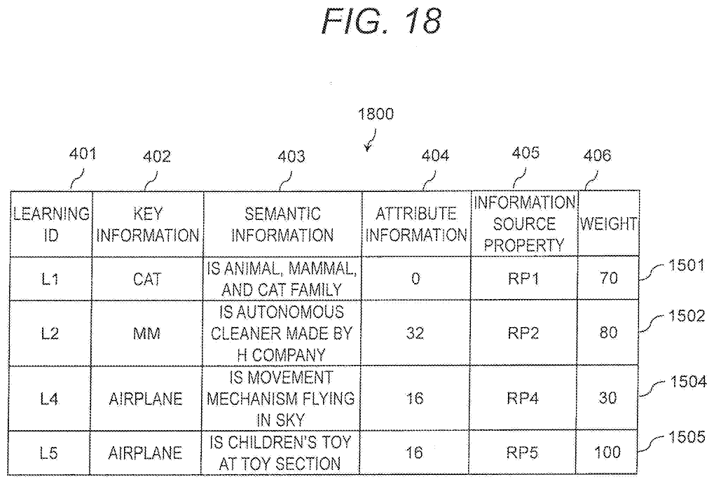

FIG. 18 is a diagram illustrating an example of the update list. In an update list 1800, all values of the weights 406 is not 100 as in the learning list 1500 but values calculated in the update list generation processing (step S1606).

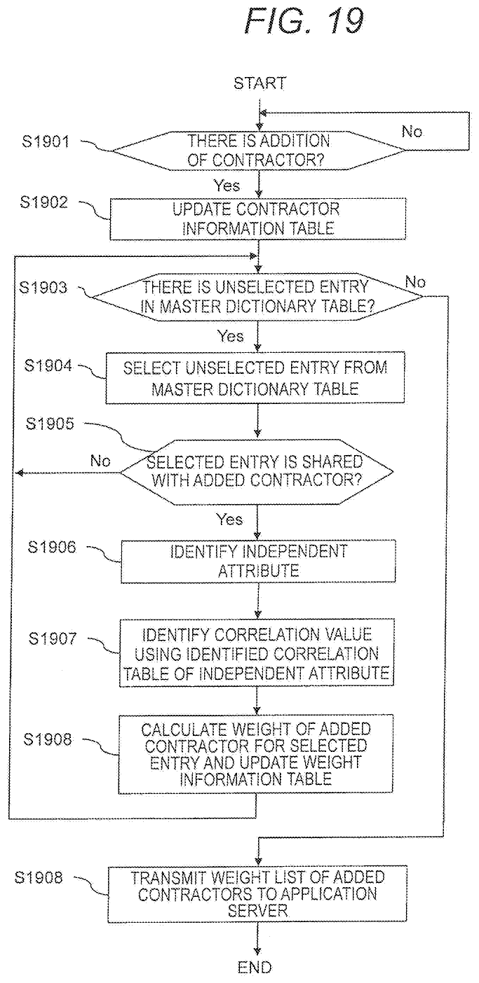

FIG. 19 is a flowchart showing a weight update processing procedure example in the case where there is addition of a contractor in the operation management server 110. Each processing of the operation management server 110 shown in FIG. 19 is realized by causing the processor to execute a program stored in the storage device of each of the application server 111 and the operation management server 110.

When there is the addition of the contractor, it is assumed that the contractor is also added to the information source and the distribution destination of the contractor correlation table 1001 by the operation input of a manager of the operation management server 110. Further, when the industry type 603 and the region 602 are also newly added by the addition of the contractor, it is assumed that the new industry type 603 is also added to the information source and distribution destination of the industry type correlation table 1002 by the operation input of the manager of the operation management server 110, and the new region 602 is also added to the information source and the distribution destination of the region correlation table 1003 by the operation input of the manager of the operation management server 110.

The operation management server 110 waits for an operation input from the manager to add the contractor (step S1901: No). When there is the operation input from the manager to add the contractor (step S1901: Yes), the operation management server 110 updates the contractor information table 123 (step S1902). As a result, contractor information of the newly added contractor is registered as an entry in the contractor information table 123. Here, as an example, a contractor ID 601: C4 is set as the contractor ID 601 of the added contractor.

Further, according to the update of the contractor information table 123 (step S1902), the operation management server 110 adds a column of the contractor ID 601 of the added contractor to the weight list of the weight information table 122. In the following processing, the weight 406 for the learning data set identified by the learning ID 401 is registered in the column of the contractor ID 601 of the added contractor.

Next, after the update of the contractor information table 123, the operation management server 110 determines whether or not there is an unselected entry in the master dictionary table 121 (step S1903). When there is the unselected entry (step S1903: Yes), the operation management server 110 selects the unselected entry from the master dictionary table 121 (step S1904).

The operation management server 110 determines whether or not the selected entry is shared with the added contractor (step S1905). Specifically, for example, similar to step S1704 in FIG. 17, for the learning data set to be the selected entry, the operation management server 110 refers to the attribute information 404, and identifies the presence or absence of contractor dependency, the presence or absence of industry type dependency, and the presence or absence of region dependency from the attribute information 404.

In the case where a value of the presence or absence of contractor dependency is “1” (present), the contractor identified from the information source property 405 of the learning data set and the added contractor are not matched. For this reason, the operation management server 110 determines that it is impossible to share the learning data set with respect to the added contractor. Therefore, the contractors are not identical, so that the operation management server 110 proceeds to step S1905: No. When the value of the presence or absence of contractor dependency is “0” (absent), it is not considered whether the contractors are identical or different. When a bit string of the presence or absence of contractor dependency, the presence or absence of industry type dependency, and the presence or absence of region dependency is “100”, the above processing is performed.

In the case where a value of the presence or absence of industry type dependency is “1” (present), if the industry type 603 of the added contractor and the industry type 603 identified from the information source property 405 of the learning data set are matched, the operation management server 110 determines that it is possible to share the learning data set with respect to the added contractor. Specifically, for example, in the case where the industry type 603 identified by the information source property 405 of the learning data set is “bank”, if the industry type 603 of the added contractor is “bank”, the industry types are identical, so that the operation management server 110 proceeds to step S1905: Yes. If the industry type 603 of the added contractor is not “bank”, the industry types are not identical, so that the operation management server 110 proceeds to step S1905: No. When the value of the presence or absence of industry type dependency is “0” (absent), it is not considered whether the industry types 603 are identical or different. When a bit string of the presence or absence of contractor dependency, the presence or absence of industry type dependency, and the presence or absence of region dependency is “010”, the above processing is performed.

In the case where a value of the presence or absence of region dependency is “1” (present), if the region 602 of the added contractor and the region 602 identified from the information source property 405 of the learning data set are matched, the operation management server 110 determines that it is possible to share the learning data set with respect to the added contractor. Specifically, for example, in the case where the region 602 identified by the information source property 405 of the learning data set is “A”, if the region 602 of the added contractor is “A”, the regions are identical, so that the operation management server 110 proceeds to step S1905: Yes. If the region 602 of the added contractor is not “A”, the regions are not identical, so that the operation management server 110 proceeds to step S1905: No. When the value of the presence or absence of region dependency is “0” (absent), it is not considered whether the regions 602 are identical or different. When a bit string of the presence or absence of contractor dependency, the presence or absence of industry type dependency, and the presence or absence of region dependency is “001”, the above processing is performed.

Further, when the bit strings of the presence or absence of contractor dependency, the presence or absence of industry type dependency, and the presence or absence of region dependency are “110”, “101”, and “111”, respectively, the contractors are not same. For this reason, sharing of the learning data set with the added contractor is not allowed, and the operation management server 110 proceeds to step S1905: No.

Further, when the bit string of the presence or absence of contractor dependency, the presence or absence of industry type dependency, and the presence or absence of region dependency is “011”, as long as the industry types are identical and the regions are identical, sharing of the learning data set with the added contractor is allowed, and the operation management server 110 proceeds to step S1905: Yes.

Further, when the bit string of the presence or absence of contractor dependency, the presence or absence of industry type dependency, and the presence or absence of region dependency is “000”, sharing of the learning data set is unconditionally allowed, and the operation management server 110 proceeds to step S1905: Yes.

Next, similar to step S1705, the operation management server 110 identifies the independent attribute for the learning data set (selected entry) that can be shared with the added contractor (step S1906). In the case of step S1906, the independent attribute necessarily includes the contractor dependency.

Specifically, for example, when the bit string of the presence or absence of contractor dependency, the presence or absence of industry type dependency, and the presence or absence of region dependency is “011”, the independent attribute is the contractor dependency. When the bit string of the presence or absence of contractor dependency, the presence or absence of industry type dependency, and the presence or absence of region dependency is “001”, the independent attributes are the contractor dependency and the industry type dependency. When the bit string of the presence or absence of contractor dependency, the presence or absence of industry type dependency, and the presence or absence of region dependency is “010”, the independent attributes are the contractor dependency and the region dependency. When the bit string of the presence or absence of contractor dependency, the presence or absence of industry type dependency, and the presence or absence of region dependency is “000”, the independent attributes are the contractor dependency, the industry type dependency, and the region dependency.

Next, similar to step S1706, the operation management server 110 identifies a correlation value using the correlation table 124 of the independent attribute identified in step S1906 (step S1907). If the identified independent attribute is contractor dependency, the operation management server 110 refers to the contractor correlation table 1001, if the identified independent attribute is industry type dependency, the operation management server 110 refers to the industry type correlation table 1002, and if the identified independent attribute is region dependency, the operation management server 110 refers to the region correlation table 1003.

The operation management server 110 sets the contractor identified by the contractor ID 601 of the information source property 405 of the learning data set (selected entry) as the “information source” and sets the added contractor as the “distribution destination”, for the correlation table 124 of the reference destination. Specifically, for example, when the correlation table 124 of the reference destination is the contractor correlation table 1001, the operation management server 110 identifies the contractor ID 601 of the information source property 405 of the learning data set (selected entry) from the information source, and identifies the contractor ID 601 of the added contractor from the distribution destination. For example, when the information source is “C1” and the distribution destination is “C4”, the operation management server 110 acquires a correlation value “0.7” between the information source “C1” and the distribution destination “C4”.

When the correlation table 124 of the reference destination is the industry type correlation table 1002, the operation management server 110 identifies the industry type 603 of the information source property 405 of the learning data set (selected entry) from the information source, and identifies the industry type 603 of the added contractor from the distribution destination. For example, when the industry type 603 of the information source is “postal service” and the industry type 603 of the distribution destination is “bank”, the operation management server 110 acquires a correlation value “0.9” between the information source “postal service” and the distribution destination “bank”.

When the correlation table 124 of the reference destination is the region correlation table 1003, the operation management server 110 identifies the region 602 of the information source property 405 of the learning data set (selected entry) from the information source, and identifies the region 602 of the added contractor from the distribution destination. For example, when the region 602 of the information source is “A” and the region 602 of the distribution destination is “D”, the operation management server 110 acquires a correlation value “0.7” between the information source “A” and the distribution destination

Next, the operation management server 110 calculates a value of the weight 406 of the added contractor for the selected entry, and updates the weight information table 122 (step S1908). Specifically, for example, the operation management server 110 calculates the weight 406 for each distribution destination by multiplying the correlation value by the initial value (100) of the weight 406.

Specifically, for example, when the bit string of the presence or absence of contractor dependency, the presence or absence of industry type dependency, and the presence or absence of region dependency is “011”, the independent attribute is only the contractor dependency. Therefore, if the information source is “C1” and the distribution destination is “C4”, the operation management server 110 acquires a correlation value “0.7” between the information source “C1” and the distribution destination “C4” from the contractor correlation table 1001. In this case, a value W14 of the weight 406 of the information source “C1” of the selected entry considering the correlation with the distribution destination “C4” to be the added contractor becomes W14=70 (=0.7×100).

Further, when the bit string of the presence or absence of contractor dependency, the presence or absence of industry type dependency, and the presence or absence of region dependency is “001”, the independent attributes are the contractor dependency and the industry type dependency. Therefore, if the information source is “C1” and the distribution destination is “C4”, the operation management server 110 acquires a correlation value “0.7” between the information source “C1” and the distribution destination “C4” from the contractor correlation table 1001. If the industry type 603 of the information source is “postal service” and the industry type 603 of the distribution destination is “bank”, the operation management server 110 acquires a correlation value “0.9” between the information source “postal service” and the distribution destination “bank” from the industry type correlation table 1002. In this case, a value W14 of the weight 406 of the information source “C1” of the selected entry considering the correlation with the distribution destination “C4” to be the added contractor becomes W14=160 (=(0.7+0.9)×100).

Further, when the bit string of the presence or absence of contractor dependency, the presence or absence of industry type dependency, and the presence or absence of region dependency is “000”, the independent attributes are the contractor dependency, the industry type dependency, and the region dependency. Therefore, if the information source is “C1” and the distribution destination is “C4”, the operation management server 110 acquires a correlation value “0.7” between the information source “C1” and the distribution destination “C4” from the contractor correlation table 1001. If the industry type 603 of the information source is “postal service” and the industry type 603 of the distribution destination is “bank”, the operation management server 110 acquires a correlation value “0.9” between the information source “postal service” and the distribution destination “bank” from the industry type correlation table 1002. If the region 602 of the information source is “A” and the region 602 of the distribution destination is “D”, the operation management server 110 acquires a correlation value “0.7” between the information source “A” and the distribution destination “D” from the region correlation table 1003. In this case, a value W14 of the weight 406 of the information source “C1” of the selected entry considering the correlation with the distribution destination “C4” to be the added contractor becomes W14=230 (=(0.7+0.9+0.7)×100).

In this way, the value W14 of the weight 406 of the added contractor (contractor ID 601: C4) in the selected entry is added to the weight information table 122, and the operation management server 110 returns to step S1903. In step S1903, when there is no unselected entry (step S1903: No), values W14, W24, W34, W44, . . . of the weights 406 of the added contractors (contractor ID 601: C4) are added to all entries in the master dictionary table 121. A combination of a column (L1, L2, L3, L4, . . . ) of the learning ID 401 and a column (W14, W24, W34, W44, . . . ) of the weight 406 of the added contractor (contractor ID 601: C4) is called a weight list.

Further, the operation management server 110 transmits the weight list of the added contractor to all the application servers 111 (step S1908). By the above, a series of processing ends.

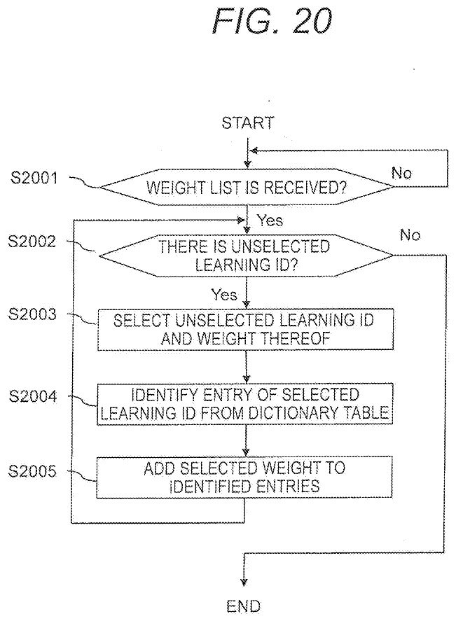

FIG. 20 is a flowchart showing a weight list reflection processing sequence example in the application server 111. Each processing of the application server 111 shown in FIG. 20 is realized by causing the processor 201 to execute a program stored in the storage device 202 of each of the application server 111 and the operation management server 110.

The application server 111 waits for the weight list from the operation management server 110 (step S2001: No). When the weight list is received (step S2001: Yes), the application server 111 determines whether or not there is an unselected learning ID 401 (step S2002). When there is the unselected learning ID 401 (step S2002: Yes), the application server 111 selects the unselected learning ID 401 and the weight 406 thereof (step S2003).

The application server 111 identifies the entry of the selected learning ID 401 from the dictionary table 131 (step S2004), adds the selected weight 406 to the identified entry (step S2005), and returns to step S2002. When there is not the unselected learning ID 401 (step S2002: No), the application server 111 ends a series of processing.

<Usefulness Redetermination Sequence Example of Learning Data Set>

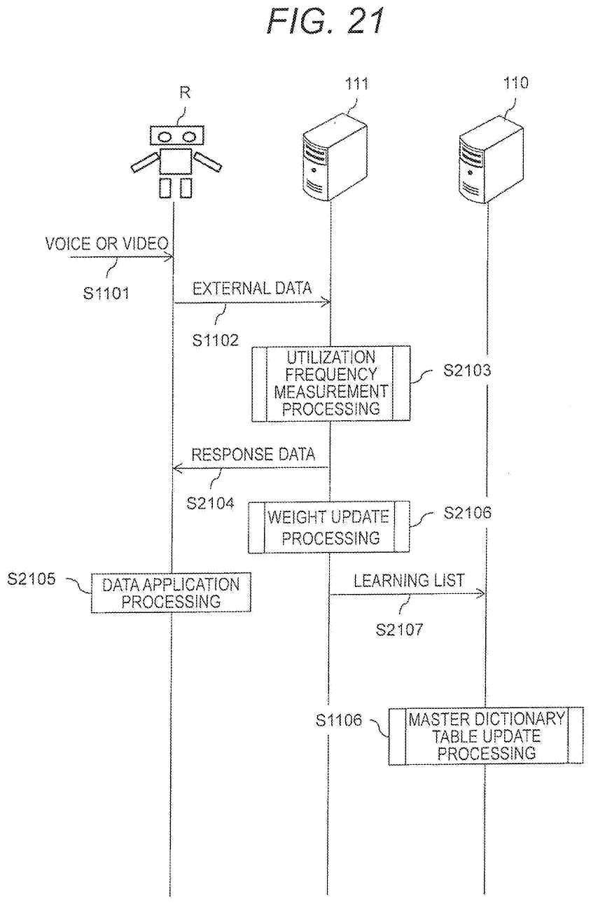

FIG. 21 is a sequence diagram showing a usefulness redetermination sequence example of a learning data set. Processing of the robot R shown in FIG. 21 is realized by causing the processor 301 to execute a program stored in the storage device 302 of the robot R. Each processing of the application server 111 and the operation management server 110 shown in FIG. 21 is realized by causing the processor 201 to execute a program stored in the storage device 202 of each of the application server 111 and the operation management server 110. The same processing as those in FIG. 11 are denoted with the same step numbers, and the description thereof is omitted.

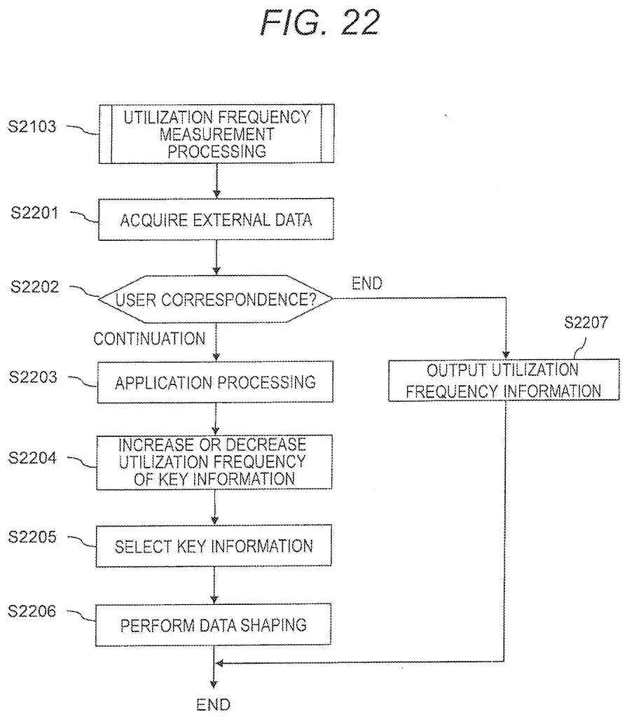

When the application server 111 receives external data from the robot R, the application server 111 executes utilization frequency measurement processing (step S2103). The utilization frequency measurement processing (step S2103) is processing of measuring the utilization frequency 407 of the key information 402, generating response data from the robot R with respect to the user interacting with the robot R, and giving the response data to the robot R. The details of the utilization frequency measurement processing (step S2103) will be described later with reference to FIG. 22. As a result, the usefulness of the learning data set can be redetermined.

The application server 111 transmits the response data to the robot R (step S2104). The robot R applies the response data, and corresponds to an instruction of the response data, like utterance, video display, an operation of the mechanism 303, and the like (step S2105).

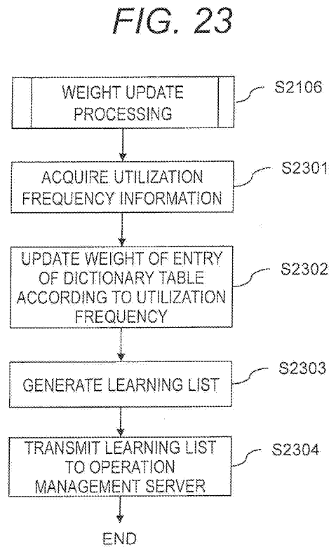

Further, when the utilization frequency 407 is output by the utilization frequency measurement processing (step S2103), the application server 111 executes weight update processing (step S2106). The weight update processing (step S2106) is processing of updating the weight 406 according to the utilization frequency 407. The details of the weight update processing (step S2106) will be described later with reference to FIG. 23.

The application server 111 transmits the learning list 1500 generated by the weight update processing (step S2106) to the operation management server 110 (step S2107). When the operation management server 110 receives the learning list 1500, the operation management server 110 executes the master dictionary table update processing shown in FIG. 11 (step S1106). As a result, the weight 406 updated by the weight update processing (step S2106) can be reflected in the master dictionary table 121.

<Utilization Frequency Measurement Processing (Step S2103)>

FIG. 22 is a flowchart showing a detailed processing procedure example of the utilization frequency measurement processing (step S2103) shown in FIG. 21. The application server 111 acquires external data (step S2201), and determines user correspondence (step S2202). When the user correspondence continues (step S2202: continuation), the application server 111 proceeds to step S2203, and when the user correspondence ends (step S2202: end), the application server 111 proceeds to step S2207. The case where the user correspondence continues is, for example, the case where the scenario of the interaction between the robot R and the user does not end, and the case where the user correspondence ends is, for example, the case where the scenario of the interaction between the robot R and the user ends or the case where the user is separated from the robot R by a predetermined distance or more. The robot R determines whether or not the scenario ends, and transmits a determination result together with the external data to the application server 111.

When the user correspondence continues (step S2202: continuation), the application server 111 executes application processing such as voice recognition and image analysis (step S2203). Then, the application server 111 increases or decreases the utilization frequency 407 of the key information 402 (step S2204). For example, when it is determined that negative words such as “different” or “not right” are included in the input data or the user has a troubled face in an image analysis result, the input data for the voice from the user is not appropriate.

Therefore, the application server 111 decreases the utilization frequency 407 of the input data to be the key information 402 by a predetermined amount. On the other hand, when it is determined that positive words are included in the input data or the user has a happy face in the image analysis result, the input data for the voice from the user is appropriate. Therefore, the application server 111 increases the utilization frequency 407 of the input data to be the key information 402 by a predetermined amount.

Further, in order to generate the response data to the robot R, the application server 111 refers to the dictionary table 131 and selects key information 402 with the largest value of the weight 406 (step S2205). Specifically, for example, the application server 111 selects the key information 402 available in advance according to the scenario of the robot R, and selects the key information 402 with the largest weight 406 from the selected key information 402.

For example, it is assumed that the external data acquired in step S2201 is text data “What is an airplane?”. In this case, the “airplane” becomes the key information 402. The application server 111 identifies an entry of which key information 402 is the “airplane” in the dictionary table 131. Here, an entry having the learning ID 401 of “L4” and an entry having the learning ID 401 of “L5” are identified. Then, the application server 111 compares the values W41 and W51 of the weights 406 of both the entries and selects the entry having the larger value.

Here, for example, it is assumed that W41<W51 is satisfied and the entry having the learning ID 401 of “L5” is selected.

Then, the application server 111 performs data shaping so as to be a response to the external data in step S2201 and generates response data (step S2206). In the above example, the application server 111 uses the value “airplane” of the key information 402 of the selected entry having the learning ID 401 of “L5” and the value “is a children's toy at toy section” of the semantic information 403 to generate response data such as “airplane is a children's toy, so it is at a toy section”. Thereby, the application server 111 transmits the response data to the robot R (step S2104).

On the other hand, when the user correspondence ends in step S2202 (step S2202: end), the application server 111 outputs the utilization frequency 407 (step S2207), and ends the series of processing. The utilization frequency 407 is a combination of the learning ID 401 of the key information 402 in which the value of the utilization frequency 407 has been changed and the utilization frequency 407 which has been changed.

<Weight Update Processing (Step S2106)>

FIG. 23 is a flowchart showing a detailed processing procedure example of the weight update processing (step S2106) shown in FIG. 21. The application server 111 acquires the utilization frequency 407 (step S2301). The operation management server 110 identifies the entry of the learning ID 401 corresponding to the utilization frequency 407 from the master dictionary table 121, and updates the weight 406 of the entry using the utilization frequency 407 (step S2302). The application server 111 increases the weight 406 according to the magnitude of the utilization frequency 407, for example. For example, if the utilization frequency 407 is +10, the application server 111 adds 1 to the weight 406 for update, and if the utilization frequency 407 is −10, the application server 111 subtracts 1 from the weight 406 for update. A correspondence relation between the increase and decrease of the weight 406 and the increase and decrease of the utilization frequency 407 is set arbitrarily.

Then, the application server 111 generates a learning list 1500 from the learning data set of the entry in which the weight 406 has been updated (step S2303), and transmits the generated learning list 1500 to the operation management server 110 (step S2304).

(1) As described above, the control system 101 according to the present embodiment has the processor 201 executing a program, the storage device 202 storing the program, and the communication IF 205 communicating with the robot R to be an example of an external device inputting and outputting voice or video. When first external data (for example, the key information 402) regarding the input voice, the text converted from the input voice, or the input video is acquired from the robot R, the control system 101 outputs first response data to the first external data to the robot R.

Further, the processor 201 gives the attribute information 404 regarding the sharing availability of the first external data to the first external data by an operation input by the manager, for example. On the basis of the attribute information 404, the processor 201 sets the weight 406 to be the indicator of the easiness of the selection of the first external data to the first external data and stores the weight 406 in the storage device 202 (the dictionary table 131 and the master dictionary table 121). When the processor 201 receives the second external data from the robot R or other robot R, the processor 201 selects the first external data from the storage device 202 (master dictionary table 121), on the basis of the weight 406 to be the indicator of the easiness of the selection of the first external data. The processor 201 generates the second response data to the second external data, on the basis of the selected first external data, and transmits the second response data to the robot R of the transmission source of the second external data.

As a result, the external data obtained by a robot R used by a certain contractor can be shared with the robot R in other region used by the contractor and the robot R used by other contractor. Therefore, each robot R can easily perform an appropriate utterance or behavior.

(2) In the above (1), the attribute information 404 may include first attribute information (presence or absence of confidentiality) indicating whether or not the first external data is to be confidential. In this case, the processor 201 determines storage or non-storage of the first external data in the storage device 202 (the dictionary table 131 and the master dictionary table 121), on the basis of the first attribute information. Specifically, for example, when there is confidentiality, the processor 201 does not store the first external data in the storage device 202 (the dictionary table 131 and the master dictionary table 121). As a result, sharing of confidential external data with other contractors can be rejected, and leakage of the external data can be prevented.

(3) In the above (1), the attribute information 404 may include second attribute information (presence or absence of contractor dependency) indicating whether or not the first external data depends on a user (contractor) of the robot R. In this case, the processor 201 sets the weight 406 to be the indicator of the easiness of the selection of the first external data to the first external data and stores the weight 406 in the storage device 202 (the dictionary table 131 and the master dictionary table 121), on the basis of the second attribute information.

As a result, in the case of the same contractor, the first external data can be shared with the robots R in the same or other regions. In other words, the first external data is shared with the user of the robot R used by the same contractor, so that the service related to the utterance or the behavior of the robot R is improved. On the other hand, the first external data is not shared with the robot R used by the different contractor, so that deterioration in the service related to the utterance or the behavior of the robot R used by the different contractor is suppressed.

(4) In the above (3), when the second attribute information indicates that the first external data depends on the user, the processor 201 determines setting or non-setting of the weight 406 to be the indicator of the easiness of the selection of the first external data, on the basis of an identity between a user of the robot R of a transmission source of the first external data and a user of other robot R of a transmission destination of the second external data.

As a result, if the user of the robot R of the transmission source of the first external data and the user of other robot R of the transmission destination of the second external data are the same contractor, the weight 406 is set, and if the users are the different contractors, the weight 406 is not set. Therefore, in the case of the same contractor, the first external data is likely to be selected as a generation source of the second response data to the second external data, and in the case of the different contractors, the first external data is less likely to be selected as the generation source of the second response data to the second external data.

(5) In the above (4), when the user of the robot R of the transmission source of the first external data and the user of other robot R of the second external data are identical, the processor 201 sets the weight 406 to be the indicator of the easiness of the selection of the first external data for the user of other robot R of the second external data.

As a result, it is possible to preferentially increase the value of the weight 406 of the key information 402 for the user determined to be the same.

(6) In the above (5), the processor 201 sets the weight 406 to be the indicator of the easiness of the selection of the first external data, on the basis of a correlation of other attribute information other than the second attribute information between the user of the robot R of the transmission source of the first external data and the user of other robot R of the transmission destination of the second external data.

As a result, the magnitude of the value of the weight 406 can be determined on the basis of the correlation of other attribute information, for example, the presence or absence of industry type dependency or the presence or absence of region dependency. In other words, for other correlation information, if there is relevance between the user of the robot R of the transmission source of the first external data and the user of other robot R of the transmission destination of the second external data, the weight 406 increases. If there is no relevance, the weight 406 decreases.

(7) In the above (1), the attribute information 404 may include third attribute information (presence or absence of industry type dependency) indicating whether or not the first external data depends on an industry type of the user (contractor) of the robot R. In this case, the processor 201 sets the weight 406 to be the indicator of the easiness of the selection of the first external data to the first external data and stores the weight 406 in the storage device 202 (the dictionary table 131 and the master dictionary table 121), on the basis of the third attribute information

As a result, in the case of the same industry type, the first external data can be shared with the robots R of the same or other contractors and the same or other regions. In other words, the first external data is shared with the user of the robot R used by the contractor of the same industry type, so that the service of the industry type related to the utterance or the behavior of the robot R is improved. On the other hand, the first external data is not shared with the robot R used by the contractor of the different industry type, so that deterioration in the service of the different industry type related to the utterance or the behavior of the robot R used by the different contractor is suppressed.

(8) In the above (7), when the third attribute information indicates that the first external data depends on the industry type, the processor 201 determines setting or non-setting of the weight 406 to be the indicator of the easiness of the selection of the first external data, on the basis of an identity between an industry type of a user of the robot R of a transmission source of the first external data and an industry type of a user of other robot R of a transmission destination of the second external data.

As a result, if the industry types of the user of the robot R of the transmission source of the first external data and the user of other robot R of the transmission destination of the second external data are the same, the weight 406 is set, and if the industry types are different, the weight 406 is not set. Therefore, in the case of the same industry type, the first external data is likely to be selected as a generation source of the second response data to the second external data, and in the case of the different industry types, the first external data is less likely to be selected as the generation source of the second response data to the second external data.

(9) In the above (8), when the industry type of the user of the robot R of the transmission source of the first external data and the industry type of the user of other robot R of the second external data are identical, the processor 201 sets the weight 406 to be the indicator of the easiness of the selection of the first external data for the industry type.

As a result, it is possible to preferentially increase the value of the weight 406 of the key information 402 for the user whose industry type is determined to be the same.

(10) In the above (9), the processor 201 sets the weight 406 to be the indicator of the easiness of the selection of the first external data, on the basis of a correlation of other attribute information other than the third attribute information between the user of the robot R of the transmission source of the first external data and the user of other robot R of the transmission destination of the second external data.

As a result, the magnitude of the value of the weight 406 can be determined on the basis of the correlation of other attribute information, for example, the presence or absence of user dependency or the presence or absence of region dependency. In other words, for other correlation information, if there is relevance between the user of the robot R of the transmission source of the first external data and the user of other robot R of the transmission destination of the second external data, the weight 406 increases. If there is no relevance, the weight 406 decreases.

(11) In the above (1), the attribute information 404 may include fourth attribute information (presence or absence of region dependency) indicating whether or not the first external data depends on a region where a user (contractor) of the robot R provides a service by the robot R. In this case, the processor 201 sets the weight 406 to be the indicator of the easiness of the selection of the first external data to the first external data and stores the weight 406 in the storage device 202 (the dictionary table 131 and the master dictionary table 121), on the basis of the fourth attribute information.

As a result, in the case of the same region, the first external data can be shared with the robots R of the same or other contractors and the same or other industry types. In other words, the first external data is shared with the user of the robot R used by the contractor of the same region, so that the service in the region related to the utterance or the behavior of the robot R is improved. On the other hand, the first external data is not shared with the robot R used by the contractor of the different region, so that deterioration in the service in the different region related to the utterance or the behavior of the robot R used by the different contractor is suppressed.

In the identity of the region 602, for example, when the region A includes the entire area of the region B, the region B is the same region as the region A. When the region A overlaps with a part of the region B, the regions A and B may be the same regions or different regions, according to the operation input of the manager.

(12) In the above (11), when the fourth attribute information indicates that the first external data depends on the region, the processor 201 determines setting or non-setting of the weight 406 to be the indicator of the easiness of the selection of the first external data, on the basis of an identity between a region of a user of the robot R of a transmission source of the first external data and a region of a user of other robot R of a transmission destination of the second external data.

As a result, if the regions of the user of the robot R of the transmission source of the first external data and the user of other robot R of the transmission destination of the second external data are the same, the weight 406 is set, and if the regions are different, the weight 406 is not set. Therefore, in the case of the same region, the first external data is likely to be selected as a generation source of the second response data to the second external data, and in the case of the different regions, the first external data is less likely to be selected as the generation source of the second response data to the second external data.

The same region means that the region 602 related to the user of the robot R of the transmission source of the first external data and the region 602 related to the user of other robot R of the transmission destination of the second external data are the same. For example, if the regions 602 of the users of robots R is A, B, C, and D and the regions 602 of the users of other robots R is B, C, D, and E, B, C, and D overlap, so that the same regions are determined. Further, when the number of overlapping regions is larger than the number of non-overlapping regions, both the users may be determined to be the same region. In this example, since the overlapping regions are three regions B, C, and D and the non-overlapping regions are two regions A and E, both the users are determined to be the same region. In the case of the same number, setting may be performed so that the same region is determined by the initial setting.

Further, the same region may mean that the assignment destination of the robot R of the transmission source of the first external data and the assignment destination of other robot R of the transmission destination of the second external data are the same region. In this case, if the assignment destination of the robot R is the A region and the assignment destination of other robot R is the A region, the same region is determined, and if the assignment destination of other robot R is the C region, the different regions are determined.

(13) In the above (12), when the region of the user of the robot R of the transmission source of the first external data and the region of the user of other robot R of the second external data are identical, the processor 201 sets the weight 406 to be the indicator of the easiness of the selection of the first external data for the user of other robot R of the second external data.

As a result, the magnitude of the value of the weight 406 can be determined on the basis of the correlation of other attribute information, for example, the presence or absence of user dependency or the presence or absence of industry type dependency. In other words, for other correlation information, if there is relevance between the user of the robot R of the transmission source of the first external data and the user of other robot R of the transmission destination of the second external data, the weight 406 increases. If there is no relevance, the weight 406 decreases.

(14) In the above (13), the processor 201 sets the weight 406 to be the indicator of the easiness of the selection of the first external data, on the basis of a correlation of other attribute information other than the fourth attribute information between the user of the robot R of the transmission source of the first external data and the user of other robot R of the transmission destination of the second external data.

As a result, the magnitude of the value of the weight 406 can be determined on the basis of the correlation of other attribute information, for example, the presence or absence of user dependency or the presence or absence of industry type dependency. In other words, for other correlation information, if there is relevance between the user of the robot R of the transmission source of the first external data and the user of other robot R of the transmission destination of the second external data, the weight 406 increases. If there is no relevance, the weight 406 decreases.

(15) In the above (1), the processor 201 increases or decreases the utilization frequency 407 of the first external data, on the basis of content of the first external data, and updates the weight 406 to be the indicator of the easiness of the selection of the first external data, on the basis of the utilization frequency 407. As a result, for example, if the content of the first external data is positive, the utilization frequency 407 increases. Accordingly, the weight 406 also increases, and it is likely to be selected as a generation source of the second response data to the second external data. On the other hand, if the content of the first external data is negative, the utilization frequency 407 decreases. Accordingly, the weight 406 also decreases, and it is less likely to be selected as the generation source of the second response data to the second external data.

In the embodiment described above, for the key information 402 in which the bit value of “corresponding to the unnecessary word” in the attribute information 404 is “1”, the application server 111 may not store the learning data set in the dictionary table 131, similar to “confidential”. Alternatively, for the key information 402, the application server 111 stores the learning data set in the dictionary table 131. However, the value of the weight 406 may be set to the value (for example, 50) smaller than the initial value 100, instead of the initial value 100.

Further, since there are three types of attributes of “corresponding to the unnecessary word”, the application server 111 may set the smaller value of the set weight 406 as the number of bit values “1” increases. For example, when the bit string of the attribute of “corresponding to the unnecessary word” is any one of “100”, “010”, and “001”, the application server 111 may set the value of the weight 406 of the key information to “50”, when the bit string of the attribute of “corresponding to the unnecessary word” is any one of “110”, “101”, and “011”, the application server 111 may set the value of the weight 406 of the key information to “25”, and when the bit string of the attribute of “corresponding to the unnecessary word” is “111”, the application server 111 may set the value of the weight 406 of the key information to “0”.

As described above, since the initial value of the weight 406 decreases as the word is the unnecessary word, the key information 402 is less likely to be selected as a generation source of the second response data to the second external data. However, as described in (11), if the content is positive, the utilization frequency increases, so that the key information 402 is likely to be selected as a generation source of the second response data to the second external data. As described above, since the weight 406 varies according to the use situation, highly flexible data sharing can be achieved.

Although the present disclosure has been described with reference to example embodiments, those skilled in the art will recognize that various changes and modifications may be made in form and detail without departing from the spirit and scope of the claimed subject matter.

For example, the embodiments are described in detail to facilitate the understanding of the present invention and the present invention is not limited to including all of the described configurations. Further, a part of the configurations of the certain embodiment may be replaced by the configurations of other embodiments. Further, the configurations of other embodiments may be added to the configurations of the certain embodiment. Further, for a part of the configurations of the individual embodiments, addition of other configurations, configuration removal, and configuration replacement may be performed.

Further, a part or all of the individual configurations, functions, processing units, and processing mechanisms may be realized by hardware by designing by integrated circuits or may be realized by software by analyzing and executing programs for realizing the functions by the processor.

Information such as the programs, the tables, and the files for realizing the individual functions may be stored in a storage device such as a memory, a hard disk, and a solid state drive (SSD) or a recording medium such as an integrated circuit (IC) card, an SD card, or a digital versatile disc (DVD).

Further, only control lines or information lines necessary for explanation are shown and the control lines or information lines do not mean all control lines or information lines necessary for implementation. In actuality, almost all configurations may be mutually connected.

What is claimed is:

1. A control system that has a processor executing a program, a storage device storing the program, and a communication interface communicating with an external device inputting and outputting voice or video, and when first external data regarding input voice, input video, an input text, or a text converted from the input voice or video is acquired from the external device, outputs first response data to the first external data to the external device, wherein
the processor
gives attribute information, which is an indicator of sharing availability of the first external data, to the first external data, and
sets a weight to be an indicator of easiness of selection of the first external data to the first external data and stores the weight in the storage device, on the basis of the attribute information.

2. The control system according to claim 1, wherein
when second external data is received from the external device or other external device, the processor selects the first external data from the storage device, on the basis of the weight to be the indicator of the easiness of the selection of the first external data,
generates second response data to the second external data, on the basis of the selected first external data, and
transmits the second response data to an external device of a transmission source of the second external data.

3. The control system according to claim 2, wherein
the attribute information includes first attribute information indicating whether or not the first external data is to be confidential, and
the processor determines storage or non-storage of the first external data in the storage device, on the basis of the first attribute information.

4. The control system according to claim 2, wherein
the attribute information includes second attribute information indicating whether or not the first external data depends on a user of the external device, and
the processor sets the weight to be the indicator of the easiness of the selection of the first external data to the first external data and stores the weight in the storage device, on the basis of the second attribute information.

5. The control system according to claim 4, wherein
when the second attribute information indicates that the first external data depends on the user, the processor determines setting or non-setting of the weight to be the indicator of the easiness of the selection of the first external data, on the basis of an identity between a user of an external device of a transmission source of the first external data and a user of the other external device of a transmission destination of the second external data.

6. The control system according to claim 5, wherein
when the user of the external device of the transmission source of the first external data and the user of the other external device of the second external data are identical, the processor sets the weight to be the indicator of the easiness of the selection of the first external data for the user.

7. The control system according to claim 6, wherein
the processor sets the weight to be the indicator of the easiness of the selection of the first external data for the user, on the basis of a correlation of other attribute information other than the second attribute information between the user of the external device of the transmission source of the first external data and the user of other external device of the transmission destination of the second external data.

8. The control system according to claim 2, wherein
the attribute information includes third attribute information indicating whether or not the first external data depends on an industry type of a user of the external device, and
the processor sets the weight to be the indicator of the easiness of the selection of the first external data to the first external data and stores the weight in the storage device, on the basis of the third attribute information.

9. The control system according to claim 8, wherein
when the third attribute information indicates that the first external data depends on the industry type, the processor determines setting or non-setting of the weight to be the indicator of the easiness of the selection of the first external data, on the basis of an identity between an industry type of a user of an external device of a transmission source of the first external data and an industry type of a user of the other external device of a transmission destination of the second external data.

10. The control system according to claim 9, wherein
when the industry type of the user of the external device of the transmission source of the first external data and the industry type of the user of the other external device of the second external data are identical, the processor sets the weight to be the indicator of the easiness of the selection of the first external data for the user of the other external device of the second external data.

11. The control system according to claim 10, wherein
the processor sets the weight to be the indicator of the easiness of the selection of the first external data, on the basis of a correlation of other attribute information other than the third attribute information between the user of the external device of the transmission source of the first external data and the user of the other external device of the transmission destination of the second external data.

12. The control system according to claim 2, wherein
the attribute information includes fourth attribute information indicating whether or not the first external data depends on a region where a user of the external device provides a service by the external device, and
the processor sets the weight to be the indicator of the easiness of the selection of the first external data to the first external data and stores the weight in the storage device, on the basis of the fourth attribute information.

13. The control system according to claim 12, wherein
when the fourth attribute information indicates that the first external data depends on the region, the processor determines setting or non-setting of the weight to be the indicator of the easiness of the selection of the first external data, on the basis of an identity between a region of a user of an external device of a transmission source of the first external data and a region of a user of the other external device of a transmission destination of the second external data.

14. The control system according to claim 13, wherein
when the region of the user of the external device of the transmission source of the first external data and the region of the user of the other external device of the second external data are identical, the processor sets the weight to be the indicator of the easiness of the selection of the first external data for the user of the other external device of the second external data.

15. The control system according to claim 14, wherein
the processor sets the weight to be the indicator of the easiness of the selection of the first external data, on the basis of a correlation of other attribute information other than the fourth attribute information between the user of the external device of the transmission source of the first external data and the user of other external device of the transmission destination of the second external data.

16. The control system according to claim 2, wherein
the processor increases or decreases the utilization frequency of the first external data, on the basis of content of the first external data, and updates the weight to be the indicator of the easiness of the selection of the first external data, on the basis of the utilization frequency.

17. A control method by a control system that has a processor executing a program, a storage device storing the program, and a communication interface communicating with an external device inputting and outputting voice or video, and when first external data regarding input voice, input video, an input text, or a text converted from the input voice or video is acquired from the external device, outputs first response data to the first external data to the external device, wherein
the processor
gives attribute information regarding sharing availability of the first external data to the first external data, and
sets a weight to be an indicator of easiness of selection of the first external data to the first external data and stores the weight in the storage device, on the basis of the attribute information.

18. The control method according to claim 17, wherein
when second external data is received from the external device or other external device, the first external data is selected from the storage device on the basis of the weight to be the indicator of the easiness of the selection of the first external data,
second response data to the second external data is generated on the basis of the selected first external data, and
the second response data is transmitted to an external device of a transmission source of the second external data.
